(19) United States
(12) Patent Application Publication
(10) Pub. No.: US 2021/0135858 A1
(43) Pub. Date: May 6, 2021

(54) Information Processing Method, Terminal Device, and Network System

(71) Applicant: Huawei Technologies Co., Ltd., Shenzhen (CN)

(72) Inventors: Cheng Kang Chu, Singapore (SG); David Naccache, Paris (FR); Jie Shi, Singapore (SG); Chengfang Fang, Singapore (SG); Xiwen Fang, Shanghai (CN)

(21) Appl. No.: 17/149,923

(22) Filed: Jan. 15, 2021

Related U.S. Application Data
(63) Continuation of application No. PCT/CN2018/105487, filed on Sep. 13, 2018.

(51) Int. Cl. H04L 9/08; H04L 29/06

(52) U.S. Cl. CPC H04L 9/0827; H04L 9/0869; H04L 9/0822; H04L 63/0442

(57) ABSTRACT

An information processing method, a terminal device, and a network system include encrypting, by a first terminal, an authorization key based on a public key of a second terminal to obtain an authorization key ciphertext corresponding to the second terminal, and sending, by the first terminal, the authorization key ciphertext to the second terminal such that the second terminal decrypts the authorization key ciphertext based on a private key of the second terminal to obtain the authorization key, and then performs file decryption.

### CROSS-REFERENCE TO RELATED APPLICATIONS

This application is a continuation of International Patent Application No. PCT/CN2018/105487 filed on Sep. 13, 2018, which is hereby incorporated by reference in its entirety.

### TECHNICAL FIELD

This application relates to communications technologies, and in particular, to an information processing method, a terminal device, and a network system.

### BACKGROUND

With increasing popularization of cloud services, most users are accustomed to uploading and storing personal files in a cloud, thereby implementing cloud storage.

Although cloud storage has many advantages, such as anytime and anywhere access, synchronous management, data backup, and data sharing, users still have great concerns about security and privacy of cloud storage. Currently, most cloud servers have their own security key mechanisms and encrypt and decrypt files using keys provided by the cloud servers.

To provide services at any time, cloud servers are usually online. Consequently, hackers may easily use system vulnerabilities to steal keys and user files. This brings security risks to user privacy.

### SUMMARY

Embodiments of this application provide an information processing method, a terminal device, and a server, to ensure data security of a user file stored in a cloud and avoid a security risk.

According to a first aspect, an embodiment of this application provides an information processing method, including encrypting, by a first terminal device, an authorization key of a current version based on a public key of each of at least one second terminal device, to obtain an authorization key ciphertext corresponding to each second terminal device, and sending, by the first terminal device to each second terminal device through a server, the authorization key ciphertext corresponding to each second terminal device, where the authorization key ciphertext corresponding to each second terminal device is used to enable each second terminal device to decrypt, based on a private key of each second terminal device, the authorization key ciphertext corresponding to each second terminal device, to obtain the authorization key of the current version, obtain a file key from the server based on the authorization key of the current version, and perform file decryption based on the file key.

In the information processing method, the authorization key ciphertext is encrypted based on the public key of each second terminal device, and can be decrypted only using the private key of each second terminal device. Therefore, a device that transmits or stores the authorization key ciphertext, such as the server, cannot decrypt the authorization key ciphertext. Even if a hacker can obtain the authorization key ciphertext by exploiting a vulnerability, the hacker cannot decrypt the authorization key ciphertext. This effectively avoids various data security problems and security risks, and ensures data security of user files stored in a cloud and user privacy.

In an implementation, the method further includes encrypting, by the first terminal device, a key of at least one encrypted file based on the authorization key of the current version, to obtain a key ciphertext of the at least one encrypted file, and sending, by the first terminal device, the key ciphertext of the at least one encrypted file to the server, where the key ciphertext of the at least one encrypted file is used to enable each second terminal device to obtain the key ciphertext of the at least one encrypted file from the server, decrypt the key ciphertext of the at least one encrypted file based on the authorization key of the current version, to obtain the key of the at least one encrypted file, and decrypt, based on the key of each encrypted file, each encrypted file stored on the server.

In the information transmission method, after encrypting the key of the at least one encrypted file based on the authorization key of the current version, the first terminal device transmits the key of the at least one encrypted file to the server such that each second terminal device can decrypt the key of the at least one encrypted file based on the obtained authorization key of the current version, to obtain the key of the at least one encrypted file. In this way, each encrypted file is decrypted based on the key of each encrypted file, thereby avoiding leakage of the key of the encrypted file, ensuring security of the key, and ensuring security of user data.

Even if the server or another device may learn of the key ciphertext of the at least one encrypted file, because the server or the other device cannot learn of the authorization key of the current version, the server or the other device cannot obtain the key of the at least one encrypted file through decryption. Consequently, file decryption cannot be implemented, thereby effectively ensuring data security.

In another implementation, the method further includes determining, by the first terminal device, a random number of a preset quantity of bits, and sending the random number of the preset quantity of bits to each second terminal device through the server, where the random number of the preset quantity of bits is used to enable each second terminal device to determine the public key and the private key of each second terminal device.

In still another implementation, the method further includes encrypting, by the first terminal device, the authorization key of the current version based on a private key or a secret trapdoor parameter of the first terminal device, to obtain an authorization key of a next version, encrypting, by the first terminal device, the authorization key of the next version based on a public key of each of at least one third terminal device, to obtain an authorization key ciphertext corresponding to each third terminal device, and sending, by the first terminal device to each third terminal device through the server, the authorization key ciphertext corresponding to each third terminal device, where the authorization key ciphertext corresponding to each third terminal device is used to enable each third terminal device to decrypt, based on a private key of each third terminal device, the authorization key ciphertext corresponding to each third terminal device, to obtain the authorization key of the next version, obtain the file key from the server based on the authorization key of the next version, and perform file decryption based on the file key.

In the information processing method, the first terminal device may update the authorization key based on the private key of the first terminal device, separately encrypt the updated authorization key based on the public key of the at least one third terminal device, to obtain the authorization key ciphertext corresponding to the at least one third terminal device, and transmit the authorization key ciphertext to each third terminal device such that each third terminal device may perform decryption based on the private key corresponding to each third terminal device, to obtain the updated authorization key, obtain the file key from the server, and perform file decryption based on the file key. In this way, when the first terminal device revokes a terminal device, the revoked terminal device cannot learn of the updated authorization key and cannot perform file decryption, thereby revoking decryption permission of the revoked terminal device and effectively ensuring data security.

In yet another possible implementation, the at least one third terminal device is a destination terminal device used for file sharing after the first terminal device revokes a terminal device.

In yet another implementation, the method further includes the authorization key of the next version is used to enable each third terminal device to decrypt the authorization key of the next version based on a public key or a public trapdoor parameter of the first terminal device, to obtain the authorization key of the current version, obtain the file key from the server based on the authorization key of the current version, and perform file decryption based on the file key.

According to the information processing method, the first terminal device may send, to each third terminal device, only the authorization key ciphertext corresponding to each third terminal device such that each third terminal device performs decryption using the private key of each third terminal device, to obtain the authorization key of the next version, the first terminal device does not need to send an authorization key in a previous phase to each third terminal device, and each third terminal device may decrypt the authorization key of the next version based on the public key of the first terminal device that is learned by each third terminal device, to derive the authorization key of the previous version. In this way, the information processing method can reduce traffic and key management and storage, and improve efficiency of key distribution and management.

In yet another implementation, the method further includes sending, by the first terminal device, group owner change information to a target terminal device through the server, where the group owner change information is used to enable the target terminal device to encrypt the authorization key of the current version based on a private key or a secret trapdoor parameter of the target terminal device, to obtain the authorization key of the next version.

After a group owner terminal device is changed, the changed group owner terminal device may update the authorization key based on a private key of the changed group owner terminal device, thereby effectively ensuring file access security after a group owner is updated, and ensuring data security.

In yet another implementation, the method further includes determining, by the first terminal device from a preset first database, an authorization key of a next version of the authorization key of the current version, where the first database includes authorization keys of a plurality of versions of the first terminal device, encrypting, by the first terminal device, the authorization key of the next version based on a public key of each of at least one fourth terminal device, to obtain an authorization key ciphertext corresponding to each fourth terminal device, and sending, by the first terminal device to each fourth terminal device through the server, the authorization key ciphertext corresponding to each fourth terminal device, where the authorization key ciphertext corresponding to each fourth terminal device is used to enable each fourth terminal device to decrypt, based on a private key of each fourth terminal device, the authorization key ciphertext corresponding to each fourth terminal device, to obtain the authorization key of the next version, obtain the file key from the server based on the authorization key of the next version, and perform file decryption based on the file key.

In the information processing method, the first terminal device may determine, from the preset first database, the authorization key of the next version of the authorization key of the current version, to update the authorization key, separately encrypt the authorization key of the next version based on the public key of the at least one fourth terminal device, to obtain the authorization key ciphertext corresponding to the at least one fourth terminal device, and transmit the authorization key ciphertext to each fourth terminal device such that each fourth terminal device can perform decryption based on the private key corresponding to the fourth terminal device, to obtain the updated authorization key, and then perform file decryption. In this way, when the first terminal device revokes a terminal device, the revoked terminal device cannot learn of the updated authorization key and cannot perform file decryption, thereby revoking decryption permission of the revoked terminal device and effectively ensuring data security.

In yet another possible implementation, the at least one fourth terminal device is a destination terminal device used for file sharing after the first terminal device revokes a terminal device.

In yet another implementation, the method further includes obtaining, by the first terminal device, the authorization keys of the plurality of versions in the first database based on a preset first random number using a preset first one-way trapdoor function.

In yet another possible implementation, the obtaining, by the first terminal device, the authorization keys of the plurality of versions in the first database based on a preset first random number using a preset first one-way trapdoor function includes using, by the first terminal device, the first random number as an authorization key of an n^{th} version, where n is an integer greater than or equal to 2, and obtaining, by the first terminal device, an authorization key of an (n−1)^{th} version based on the authorization key of the n^{th} version using the preset first one-way trapdoor function, until an authorization key of the first version is obtained.

In yet another possible implementation, the authorization key of the next version is used to enable each fourth terminal device to obtain the authorization key of the current version based on the authorization key of the next version using the preset first one-way trapdoor function, obtain the file key from the server based on the authorization key of the current version, and perform file decryption based on the file key.

In the method, the first terminal device does not need to send the authorization key in the previous phase to each fourth terminal device, and each third terminal device may derive the authorization key of the previous version based on the authorization key of the next version using the preset first one-way trapdoor function. In this way, the information processing method can reduce traffic and key management and storage, and improve efficiency of key distribution and management.

In yet another implementation, the method further includes sending, by the first terminal device, group owner change information to a target terminal device through the server, where the group owner change information is used to enable the target terminal device to obtain a second database based on a preset second random number using a preset second one-way trapdoor function, and the second database includes authorization keys of a plurality of versions of the second terminal device.

According to a second aspect, an embodiment of this application provides an information processing method, including receiving, by a second terminal device, an authorization key ciphertext that corresponds to the second terminal device and that is sent by a first terminal device through a server, where the authorization key ciphertext corresponding to the second terminal device is a ciphertext obtained by encrypting, by the first terminal device, an authorization key of a current version based on a public key of the second terminal device, and decrypting, by the second terminal device, based on a private key of the second terminal device, the authorization key ciphertext corresponding to the second terminal device, to obtain the authorization key of the current version, obtaining a file key from the server based on the authorization key of the current version, and performing file decryption based on the file key.

In an implementation, the obtaining, by the second terminal device, a file key from the server based on the authorization key of the current version, and performing file decryption based on the file key includes obtaining, by the second terminal device, a key ciphertext of at least one encrypted file from the server, where the key ciphertext of the at least one encrypted file is a ciphertext that is obtained by encrypting, by the first terminal device, a key of the at least one encrypted file based on the authorization key of the current version and that is transmitted to the server, decrypting, by the second terminal device, the key ciphertext of the at least one encrypted file based on the authorization key of the current version, to obtain the key of the at least one encrypted file, and decrypting, by the second terminal device based on the key of each encrypted file, each encrypted file stored on the server.

In another implementation, the method further includes receiving, by the second terminal device, a random number that is of a preset quantity of bits and that is sent by the first terminal device through the server, and determining the public key and the private key of the second terminal device based on the random number of the preset quantity of bits.

According to a third aspect, an embodiment of this application may further provide an apparatus on a first terminal device side. The apparatus may be a first terminal device, or may be a chip in a first terminal device.

The apparatus can implement any function of the first terminal device in any implementation of the first aspect. The function may be implemented using hardware, or may be implemented by executing, by hardware, corresponding software. The hardware or the software includes one or more units corresponding to the functions.

In a possible implementation, when the apparatus is the first terminal device, the first terminal device may include a processor and a transceiver. The processor is configured to support the first terminal device in performing a corresponding function in the foregoing method. The transceiver is configured to support communication between the first terminal device and a server, to send information or an instruction in the foregoing method to a second terminal device through the server. Optionally, the first terminal device may further include a memory. The memory is configured to be coupled to the processor, and stores a program instruction and data that are necessary for the first terminal device.

In a possible implementation, the apparatus includes a processor, a memory, a transceiver, an antenna, and an input/output apparatus. The processor is mainly configured to control the entire apparatus, and execute a computer program instruction, to support the apparatus in performing an action and the like described in any method embodiment in the first aspect. The memory is mainly configured to store a program instruction and data that are necessary for the first terminal device. The transceiver is mainly configured to perform conversion between a baseband signal and a radio frequency signal, and process a radio frequency signal. The antenna is mainly configured to send and receive a radio frequency signal in an electromagnetic wave form. The input/output apparatus, such as a touchscreen, a display, or a keyboard, is mainly configured to receive data input by a user and data output to the user.

In a possible implementation, when the apparatus is a chip in the first terminal device, the chip includes a processing module and a transceiver module. The processing module may be, for example, a processor. For example, the processor is configured to generate various messages and signaling, and perform processing such as encoding, modulation, and amplification on the various messages after the messages are encapsulated according to protocols. The processor may be further configured to perform demodulation, decoding, and decapsulation to obtain the signaling and messages. The transceiver module may be, for example, an input/output interface, a pin, or a circuit on the chip. The processing module may execute a computer-executable instruction stored in a storage unit, to support the first terminal device in performing a corresponding function in the foregoing method. Optionally, the storage unit may be a storage unit, such as a register or a cache, in the chip. Alternatively, the storage unit may be a storage unit that is in the first terminal device and that is located outside the chip, such as a read-only memory (ROM) or another type of static storage device that can store static information and an instruction, a random-access memory (RAM), or the like.

The processor mentioned anywhere above may be a general-purpose central processing unit (CPU), a microprocessor, an application-specific integrated circuit (ASIC), or one or more integrated circuits for controlling program execution of the information processing method in the first aspect.

According to a fourth aspect, an embodiment of this application provides an apparatus applied to a second terminal device side. The apparatus may be a second terminal device, or may be a chip in a second terminal device.

The apparatus can implement any function of the second terminal device in any implementation of the second aspect. The function may be implemented using hardware, or may be implemented by executing, by hardware, corresponding software. The hardware or the software includes one or more units corresponding to the functions.

In a possible implementation, the apparatus may be the second terminal device. The second terminal device includes a processor and a transceiver. The processor is configured to support the second terminal device in performing a corresponding function in the foregoing method. The transceiver is configured to support communication between the second terminal device and a server, to receive information or an instruction in the foregoing method sent by the first terminal device through the server. Optionally, the second terminal device may further include a memory. The memory is configured to be coupled to the processor, and stores a program instruction and data that are necessary for the second terminal device.

In a possible implementation, the apparatus includes a processor, a memory, a transceiver, an antenna, and an input/output apparatus. The processor is mainly configured to control the entire apparatus, and execute a computer program instruction, to support the apparatus in performing an action and the like described in any method embodiment in the second aspect. The memory is mainly configured to store a program instruction and data that are necessary for the second terminal device. The transceiver is mainly configured to perform conversion between a baseband signal and a radio frequency signal, and process a radio frequency signal. The antenna is mainly configured to send and receive a radio frequency signal in an electromagnetic wave form. The input/output apparatus, such as a touchscreen, a display, or a keyboard, is mainly configured to receive data input by a user and data output to the user.

In a possible implementation, the apparatus may be a chip in the second terminal device. The chip includes a processing module and a transceiver module. The processing module may be, for example, a processor. For example, the processor is configured to generate various messages and signaling, and perform processing such as encoding, modulation, and amplification on the various messages after the messages are encapsulated according to protocols. The processor may be further configured to perform demodulation, decoding, and decapsulation to obtain the signaling and messages. The transceiver module may be, for example, an input/output interface, a pin, or a circuit on the chip. The processing module may execute a computer-executable instruction stored in a storage unit, to support the second terminal device in performing a corresponding function in the foregoing method. Optionally, the storage unit may be a storage unit, such as a register or a cache, in the chip. Alternatively, the storage unit may be a storage unit that is in the second terminal device and that is located outside the chip, such as a ROM or another type of static storage device that can store static information and an instruction, a RAM, or the like.

Any processor mentioned above may be a CPU, a microprocessor, an ASIC, or one or more integrated circuits for controlling program execution of the information processing method in the second aspect.

According to a fifth aspect, an embodiment of this application provides a computer-readable storage medium. The computer-readable storage medium stores an instruction, and the instruction may be executed by one or more processors of a processing circuit. When the instruction is run on a computer, the computer is enabled to perform the information processing method in any possible implementation of either of the first aspect or the second aspect.

According to a sixth aspect, an embodiment of this application provides a computer program product that includes an instruction. When the computer program product is run on a computer, the computer is enabled to perform the information processing method in any possible implementation of either of the first aspect or the second aspect.

According to a seventh aspect, this application provides a chip system. The chip system includes a processor configured to support a first terminal device or a second terminal device in implementing functions in the first aspect or the second aspect, for example, generate or process data and/or information in the foregoing aspects. In a possible design, the chip system further includes a memory, and the memory is configured to store a program instruction and data that are necessary for a data sending device. The chip system may include a chip, or may include a chip and another discrete component.

According to an eighth aspect, an embodiment of this application provides a network system, including a first terminal device, a server, and at least one second terminal device. The server is connected to the first terminal device, and the service is further connected to each second terminal device. The first terminal device is any one of the foregoing first terminal devices, and each second terminal device is any one of the foregoing second terminal devices.

The embodiments of this application provide the information processing method, the terminal device, and the network system. The first terminal device may encrypt the authorization key of the current version based on the public key of each of at least one second terminal device, to obtain the authorization key ciphertext corresponding to each second terminal device, send, through the server to each second terminal device, the authorization key ciphertext corresponding to each second terminal device, so that each second terminal device decrypts, based on the private key of each second terminal device, the authorization key ciphertext corresponding to each second terminal device, to obtain the authorization key of the current version, then obtain the file key from the server based on the authorization key of the current version, and perform file decryption based on the file key. In the information processing method, the authorization key ciphertext is encrypted based on the public key of each second terminal device, and can be decrypted only by using the private key of each second terminal device. Therefore, a device that transmits or stores the authorization key ciphertext, such as the server, cannot decrypt the authorization key ciphertext. Even if a hacker can obtain the authorization key ciphertext by exploiting a vulnerability, the hacker cannot decrypt the authorization key ciphertext. This effectively avoids various data security problems and security risks, and ensures data security of user files stored in a cloud and user privacy.

### BRIEF DESCRIPTION OF DRAWINGS

FIG. 1 is an architectural diagram of a network system to which an information processing method is applicable according to an embodiment of this application;

FIG. 2 is a flowchart of an information processing method according to an embodiment of this application;

FIG. 3 is a flowchart of an information processing method according to an embodiment of this application;

FIG. 4 is a schematic diagram of an application scenario of an information processing method according to an embodiment of this application;

FIG. 5 is a schematic diagram of updating an authorization key in an information processing method according to an embodiment of this application;

FIG. 6 is a flowchart of an information processing method according to an embodiment of this application;

FIG. 7 is a schematic diagram of an application scenario of an information processing method according to an embodiment of this application;

FIG. 8 is a flowchart of an information processing method according to an embodiment of this application;

FIG. 9 is a flowchart of an information processing method according to an embodiment of this application;

FIG. 10 is a schematic diagram of an application scenario of an information processing method according to an embodiment of this application;

FIG. 11 is a schematic diagram of an application scenario of an information processing method according to an embodiment of this application;

FIG. 12 is a flowchart of an information processing method according to an embodiment of this application;

FIG. 13 is a flowchart of an information processing method according to an embodiment of this application;

FIG. 14 is a flowchart of an information processing method according to an embodiment of this application;

FIG. 15 is a flowchart of an information processing method according to an embodiment of this application;

FIG. 16 is a schematic structural diagram of a terminal device according to an embodiment of this application;

FIG. 17 is a structural diagram of a possible product form of a terminal device according to an embodiment of this application;

FIG. 18 is a schematic structural diagram of a terminal device according to an embodiment of this application; and

FIG. 19 is a structural diagram of a possible product form of a terminal device according to an embodiment of this application.

### DESCRIPTION OF EMBODIMENTS

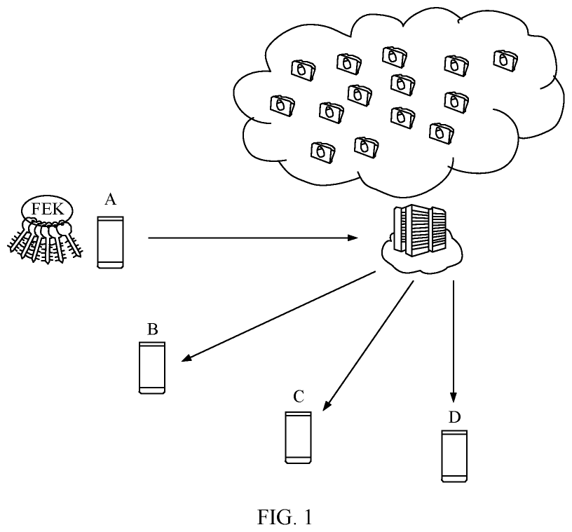

An information processing method, an apparatus, a terminal device, and a server provided in the following embodiments of this application may be applicable to a cloud storage service-based scenario, and can effectively ensure user privacy when file sharing is implemented in a group. FIG. 1 is an architectural diagram of a network system to which an information processing method is applicable according to an embodiment of this application. As shown in FIG. 1, the network system may include a server and a plurality of terminal devices. The plurality of terminal devices may be, for example, a terminal device A, a terminal device B, a terminal device C, and a terminal device D shown in FIG. 1. A file of the terminal device A may be stored in a cloud, for example, in a cloud memory controlled by the server. The terminal device A may be an owner of the file. When a file needs to be shared, the terminal device A may notify the server to create a shared folder, place at least one to-be-analyzed file in the shared folder, and set a sharing group. The terminal device A serves as a group owner terminal device of the group. Each file in the shared folder may be stored on the server in an encrypted form through a File Encryption Key (FEK) of each file. The group owner terminal device, that is, the terminal device A, may have the FEK of each file, and store the FEK of each file on the server in a form of a ciphertext. Another terminal device in the group has a decryption key of the ciphertext, and therefore can obtain the FEK of each file by accessing the server, thereby implementing file access. However, the server does not have the decryption key of the ciphertext. Therefore, the server cannot learn of the FEK of each file, and then cannot access the file. This avoids various data security problems on a server side and security risks, and ensures data security of a user file stored in a cloud.

The following describes the solutions provided in the embodiments of this application with reference to a plurality of examples.

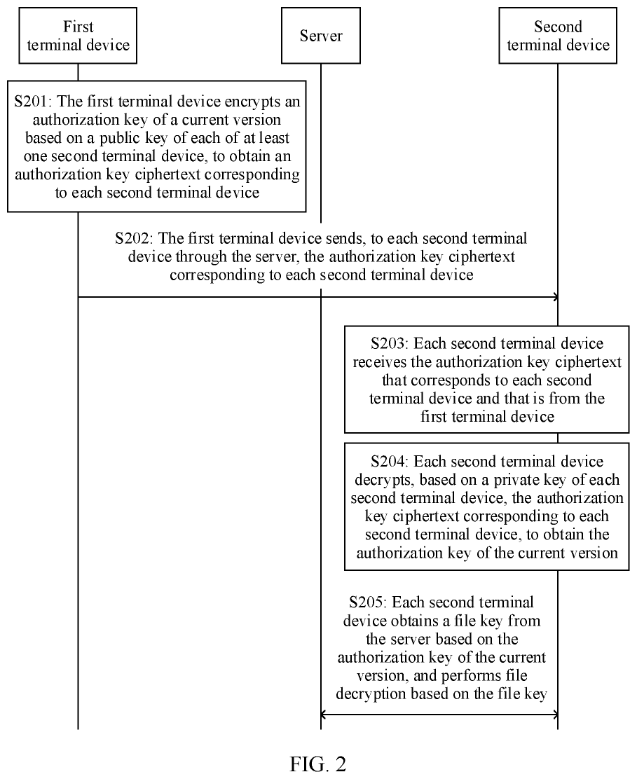

FIG. 2 is a flowchart of an information processing method according to an embodiment of this application. The information processing method shown in FIG. 2 may be alternately performed by the first terminal device and the second terminal device. As shown in FIG. 2, the information processing method may include the following steps.

S201: A first terminal device encrypts an authorization key (AK) of a current version based on a public key of each of at least one second terminal device, to obtain an authorization key ciphertext corresponding to each second terminal device.

The first terminal device may be a group owner terminal device, and the at least one second terminal device may be another terminal device that is in a group used for file sharing and that is set by the first terminal device. In the group, the first terminal device is used as a group owner terminal device, and the at least one second terminal device is used as a member terminal device. According to the methods provided in the embodiments of this application, each second terminal device may be enabled to decrypt a file stored by the first terminal device in a server, to share the file stored by the first terminal device in the server.

Each terminal device, the first terminal device or the second terminal device, has a public key and a private key of the terminal device. The public key of each terminal device may be stored on the server, or may be directly or indirectly sent to another terminal device. However, the private key of each terminal device is stored on the device, and is known only to the device. To be specific, the public key of each terminal device is known to the server or another terminal device, and the private key of each terminal device is unknown to the server or another terminal device.

For example, the server has the public key of each terminal device, and the public key of each terminal device may include information such as the public key of each second terminal device and a public key of the first terminal device. When the first terminal device needs to share a file to the at least one second terminal device, the server may send the public key of each second terminal device to the first terminal device, to notify the first terminal device of the public key of each second terminal device.

The authorization key of the current version may be an authorization key in a current phase, and may be a preset initial authorization key, or may be referred to as an authorization key of the first version, or may be a non-initial authorization key, for example, an updated authorization key.

When learning of the public key of each second terminal device, the first terminal device may encrypt the authorization key of the current version based on the public key of each second terminal device, to obtain the authorization key ciphertext corresponding to each second terminal device.

For example, if the first terminal device is a terminal device A, the at least one second terminal device may include a terminal device B, a terminal device C, and a terminal device D. A public key of the terminal device B may be denoted as PK_{B}, a public key of the terminal device C may be denoted as PK_{C}, and a public key of the terminal device D may be denoted as PK_{D}. The authorization key of the current version may be the authorization key of the first version, and is denoted as AK₁.

Therefore, the terminal device A may encrypt AK₁ based on PK_{B}, to obtain an authorization key ciphertext corresponding to the terminal device B, encrypt AK₁ based on PK_{C}, to obtain an authorization key ciphertext corresponding to the terminal device C, and encrypt AK₁ based on PK_{D}, to obtain an authorization key ciphertext corresponding to the terminal device D.

S202: The first terminal device sends, to each second terminal device through the server, the authorization key ciphertext corresponding to each second terminal device.

The first terminal device may directly send, to each second terminal device, the authorization key ciphertext corresponding to each second terminal device, or may send, to each second terminal device through another intermediate device such as the server, the authorization key ciphertext corresponding to each second terminal device.

For example, the first terminal device may first send, to the server, the authorization key ciphertext corresponding to each second terminal device, and the server sends, to each second terminal device, the authorization key ciphertext corresponding to each second terminal device.

The first terminal device may send the obtained authorization key ciphertext corresponding to the at least one second terminal device to the server, and the server distributes the authorization key ciphertext, that is, sends, to each second terminal device, the authorization key ciphertext corresponding to each second terminal device. When each second terminal device goes online, the server may forward, to each second terminal device, the authorization key ciphertext corresponding to each second terminal device.

Because the authorization key ciphertext corresponding to each second terminal device is encrypted using the public key of each second terminal device, the authorization key ciphertext corresponding to each second terminal device may be decrypted only using a private key of each second terminal device. The server or another device does not have the private key of each second terminal device. Even if the server or another device receives the authorization key ciphertext corresponding to each second terminal device, the authorization key ciphertext corresponding to each second terminal device cannot be decrypted, and the authorization key of the current version cannot be obtained.

S203: Each second terminal device receives the authorization key ciphertext that corresponds to each second terminal device and that is from the first terminal device.

S204: Each second terminal device decrypts, based on the private key of each second terminal device, the authorization key ciphertext corresponding to each second terminal device, to obtain the authorization key of the current version.

Because the authorization key ciphertext corresponding to each second terminal device is encrypted using the public key of each second terminal device, the authorization key ciphertext corresponding to each second terminal device may be decrypted only using the private key of each second terminal device. However, the private key of each second terminal device is unknown to another device, and is known only to each second terminal device. Therefore, each second terminal device may decrypt, based on the private key of each second terminal device, the authorization key ciphertext corresponding to each second terminal device, to obtain the authorization key of the current version.

A device outside the group in which the at least one second terminal device is located cannot receive the authorization key ciphertext that corresponds to the device outside the group in which the at least one second terminal device is located and that is sent by the first terminal device. Even if the device can obtain the authorization key ciphertext corresponding to the second terminal device, the device cannot obtain the authorization key of the current version because the device does not have the private key of the second terminal device and cannot decrypt the private key of the second terminal device.

S205: Each second terminal device obtains a file key from the server based on the authorization key of the current version, and performs file decryption based on the file key.

Each second terminal device may decrypt, based on the authorization key of the current version, a to-be-analyzed file that is pre-stored by the first terminal device on the server, to implement file sharing with the first terminal device.

According to the information processing method provided in this embodiment of this application, the first terminal device may encrypt the authorization key of the current version based on the public key of each of at least one second terminal device, to obtain the authorization key ciphertext corresponding to each second terminal device, send, through the server to each second terminal device, the authorization key ciphertext corresponding to each second terminal device such that each second terminal device decrypts, based on the private key of each second terminal device, the authorization key ciphertext corresponding to each second terminal device, to obtain the authorization key of the current version, then obtain the file key from the server based on the authorization key of the current version, and perform file decryption based on the file key. In the information processing method, the authorization key ciphertext is encrypted based on the public key of each second terminal device, and can be decrypted only using the private key of each second terminal device. Therefore, a device that transmits or stores the authorization key ciphertext, such as the server, cannot decrypt the authorization key ciphertext. Even if a hacker can obtain the authorization key ciphertext by exploiting a vulnerability, the hacker cannot decrypt the authorization key ciphertext. This effectively avoids various data security problems and security risks, and ensures data security of user files stored in a cloud and user privacy.

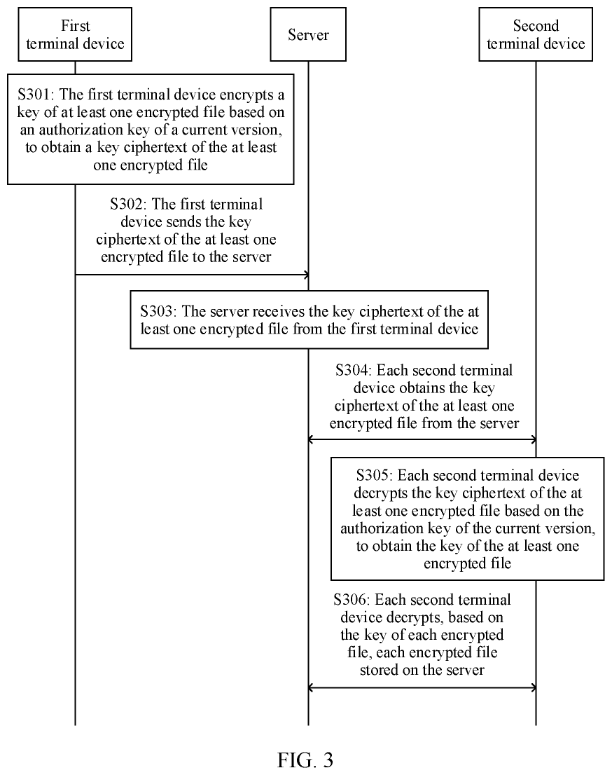

Optionally, an embodiment of this application may further provide an information processing method. FIG. 3 is a flowchart of an information processing method according to an embodiment of this application. As shown in FIG. 3, the method may further include the following steps.

S301: A first terminal device encrypts a key of at least one encrypted file based on an authorization key of a current version, to obtain a key ciphertext of the at least one encrypted file.

When the first terminal device needs to share a file, the first terminal device may notify a server to create a shared folder, put at least one to-be-shared file into the shared folder, and set a sharing group.

For each file in the shared folder, the first terminal device may select a key of each file, then encrypt each file based on the key of each file, transmit each encrypted file, and store each encrypted file on the server. The key of each file may be a key randomly selected by the first terminal device, and may also be referred to as an FEK of each file. Each encrypted file may be referred to as an encrypted file.

A member terminal device in the group may also upload a to-be-shared file.

For a member terminal device U1, the member terminal device U1 may encrypt a to-be-shared file F1 based on the authorization key of the current version, and sends the encrypted to-be-shared file F1 to the server. The server may add the encrypted to-be-shared file F1 to a folder corresponding to the group, and mark a version number, for example, a version number of the authorization key of the current version, for the to-be-shared file F1.

For the key of the at least one encrypted file, the first terminal device may use the key of the at least one encrypted file as a whole, and encrypt the key of the at least one encrypted file based on the authorization key of the current version, to obtain the key ciphertext of the at least one encrypted file, thereby packaging and encrypting the key of the encrypted file.

S302: The first terminal device sends the key ciphertext of the at least one encrypted file to the server.

The first terminal device may send the packaged and encrypted key ciphertext of the at least one encrypted file to the server.

When sending the at least one encrypted file to the server, the first terminal device may send the key ciphertext of the at least one encrypted file to the server. The first terminal device may send the key ciphertext of the at least one encrypted file to the server in other cases.

S303: The server receives the key ciphertext of the at least one encrypted file from the first terminal device.

S304: Each second terminal device obtains the key ciphertext of the at least one encrypted file from the server.

S305: Each second terminal device decrypts the key ciphertext of the at least one encrypted file based on the authorization key of the current version, to obtain the key of the at least one encrypted file.

Based on a case in which the foregoing information processing method is performed, each second terminal device may decrypt, based on a private key of each second terminal device, the authorization key ciphertext corresponding to each second terminal device, to obtain the authorization key of the current version. In this case, the authorization key of the current version is known to each second terminal device.

Therefore, each second terminal device may obtain the key ciphertext that is of the at least one encrypted file and that is stored on the server, and perform decryption based on the authorization key of the current version to obtain the key of the at least one encrypted file.

Even if the server or another device may learn of the key ciphertext of the at least one encrypted file, because the server or the other device cannot learn of the authorization key of the current version, the server or the other device cannot obtain the key of the at least one encrypted file through decryption. Consequently, file decryption cannot be implemented, thereby effectively ensuring data security.

S306: Each second terminal device decrypts, based on the key of each encrypted file, each encrypted file stored on the server.

When obtaining the key of the at least one encrypted file, each second terminal device may decrypt, based on the key of each encrypted file, each encrypted file stored on the server.

For another device, such as a device that does not belong to a group in which the at least one second terminal device is located, that cannot learn of the key of the encrypted file, because the device cannot learn of the authorization key of the current version, the device cannot obtain the key of the encrypted file through decryption, and therefore cannot access a file stored by the first terminal device on the server.

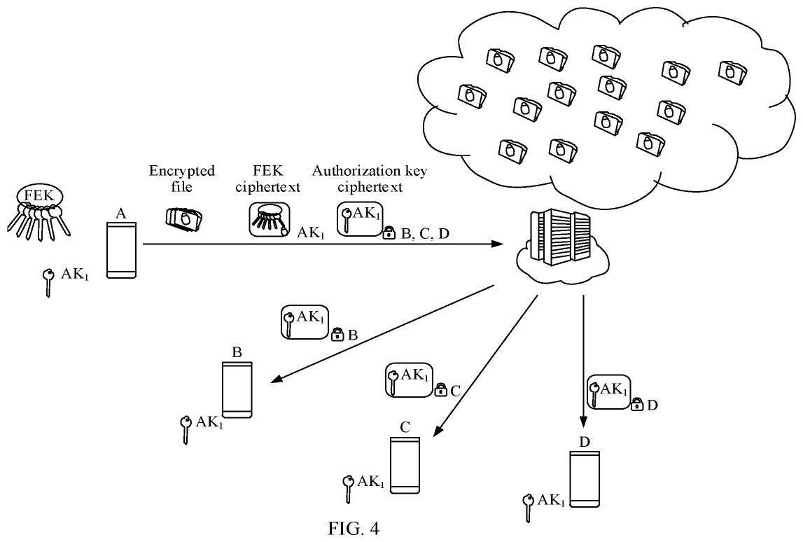

For example, FIG. 4 is a schematic diagram of an application scenario of an information processing method according to an embodiment of this application. As shown in FIG. 4, a terminal device A is a group owner terminal device, and the terminal device A expects to share a file to a terminal device B, a terminal device C, and a terminal device D.

The terminal device A may randomly select an FEK for each to-be-shared file, and encrypt each file based on the FEK of each file. For an FEK of at least one file, the terminal device A may encrypt the FEK based on an authorization key AK₁ of a current version, to obtain an FEK ciphertext. In addition, the terminal device may encrypt the authorization key AK₁ of the current version based on a public key PK_{B} of the terminal device B, to obtain an authorization key ciphertext corresponding to the terminal device B, encrypt the authorization key AK₁ of the current version based on a public key PK_{C} of the terminal device C, to obtain an authorization key ciphertext corresponding to the terminal device C, and encrypt the authorization key AK₁ of the current version based on a public key PK_{D} of the terminal device D, to obtain an authorization key ciphertext corresponding to the terminal device D.

The terminal device A sends at least one encrypted file and an FEK ciphertext of the at least one encrypted file to a server, and the server stores the at least one encrypted file and the FEK ciphertext of the at least one encrypted file.

The terminal device A further sends the authorization key ciphertext corresponding to the terminal device B, the authorization key ciphertext corresponding to the terminal device C, and the authorization key ciphertext corresponding to the terminal device D to the server. The server may send, to the terminal device B, the authorization key ciphertext corresponding to the terminal device B when the terminal device B goes online, send, to the terminal device C, the authorization key ciphertext corresponding to the terminal device C when the terminal device C goes online, and send, to the terminal device D, the authorization key ciphertext corresponding to the terminal device D when the terminal device D goes online.

The terminal device B may decrypt, based on a private key SK_{B} of the terminal device B, the authorization key ciphertext corresponding to the terminal device B, to obtain the authorization key AK₁ of the current version.

The terminal device C may decrypt, based on a private key SK_{C} of the terminal device C, the authorization key ciphertext corresponding to the terminal device C, to obtain the authorization key AK₁ of the current version.

The terminal device D may decrypt, based on a private key SK_{D} of the terminal device D, the authorization key ciphertext corresponding to the terminal device D, to obtain the authorization key AK₁ of the current version.

Regardless of the terminal device B, the terminal device C, or the terminal device D, as long as the terminal device B, the terminal device C, or the terminal device D can obtain the authorization key AK₁ of the current version, the terminal device B, the terminal device C, or the terminal device D may decrypt the FEK ciphertext on the server based on the authorization key AK₁ of the current version, to obtain the FEK of the at least one encrypted file, and then may access, based on the FEK of each encrypted file, each encrypted file stored on the server.

For a device other than the terminal device B, the terminal device C, and the terminal device D, because the device cannot learn of the authorization key of the current version, the device cannot obtain a key of the encrypted file through decryption, and therefore, cannot access a file stored by the terminal device A on the server.

In the information transmission method, after the key of the at least one encrypted file is encrypted based on the authorization key of the current version, the key of the at least one encrypted file may be transmitted to the server such that each second terminal device can decrypt the key of the at least one encrypted file based on the obtained authorization key of the current version, to obtain the key of the at least one encrypted file. In this way, each encrypted file is decrypted based on the key of each encrypted file, thereby avoiding leakage of the key of the encrypted file, ensuring security of the key, and ensuring security of user data.

Optionally, in any one of the foregoing information processing methods, the first terminal device may obtain a public key, a private key, and a modulus of the first terminal device based on a random number of a preset quantity of bits. In addition, the first terminal device further sends the random number of the preset quantity of bits to each second terminal device. The first terminal device may send the random number of the preset quantity of bits to each second terminal device through the server. That is, the first terminal device may send the random number of the preset quantity of bits to the server, to release the random number of the preset quantity of bits on the server such that the server sends the random number of the preset quantity of bits to each second terminal device.

When obtaining the random number of the preset quantity of bits, each second terminal device may obtain a public key, a private key, and a modulus of each second terminal device based on the random number of the preset quantity of bits.

In the modulus of the first terminal device and the modulus of each second terminal device, the first preset bits are the same, that is, are the random numbers of the preset quantity of bits. If the random numbers of the preset quantity of bits are random numbers of K bits, in the modulus of the first terminal device and the modulus of each second terminal device, the first K bits are the same, and are all the random numbers of the K bits.

According to the information processing method provided in this embodiment of this application, to effectively ensure data security, in some cases, the authorization key needs to be updated to an authorization key in a next phase. For example, the first terminal device may update the authorization key when a sharing user needs to be revoked, when a sharing user needs to be added, or when a to-be-shared file changes.

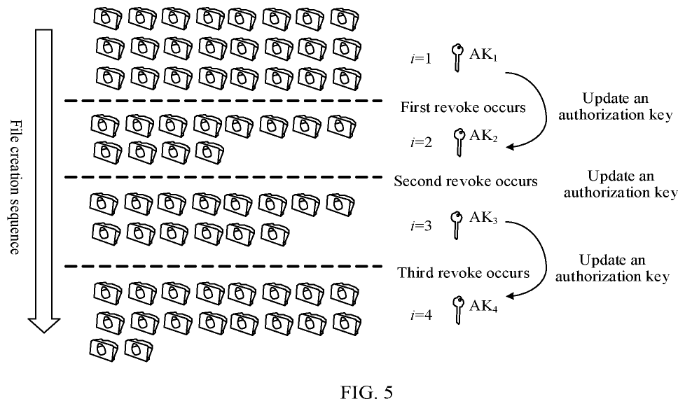

For example, FIG. 5 is a schematic diagram of updating an authorization key in an information processing method according to an embodiment of this application. As shown in FIG. 5, a group owner terminal device such as a first terminal device may update, based on an authorization key AK₁ in a first phase, the authorization key when a sharing user needs to be revoked or a to-be-shared file changes, to obtain an authorization key AK₂ in a second phase. Likewise, when a sharing user is revoked, a sharing user is added, or a to-be-shared file changes, the group owner terminal device such as the first terminal device may also update the authorization key based on the authorization key AK₁ in the second phase, to obtain an authorization key AK₃ in a third phase, and update the authorization key based on the authorization key AK₁ in the third phase, to obtain an authorization key AK₄ in a fourth phase. After the group owner terminal device is changed, the changed terminal device may update the authorization key.

In the information processing method, the authorization key may be updated only by the group owner terminal device such as the first terminal device, and a member terminal device of the group owner terminal device cannot update the authorization key. It is assumed that a sharing user is newly added in the fourth phase. For a terminal device of the newly added sharing user, the terminal device may learn of the authorization key AK₄ in the fourth phase, then automatically derive the authorization key AK₃ in the third phase based on the authorization key AK₄ in the fourth phase, then automatically derive the authorization key AK₂ in the fourth phase based on the authorization key AK₃ in the third phase, and then automatically derive the authorization key AK₁ in the first phase based on the authorization key AK₂ in the second phase. For the newly added terminal device, if the group owner terminal device such as the first terminal device cannot notify the newly added terminal device of an authorization key in a previous phase, the group owner terminal device may derive the authorization key in the previous phase based on a current authorization key. It is assumed that the terminal device is revoked in the second phase. In this case, the revoked terminal device cannot obtain the authorization key AK₃ in the third phase and the authorization key AK₄ in the fourth phase through derivation, and therefore cannot continue to access a file after the second phase.

In an implementation, the first terminal device used as the group owner terminal device may update a key based on a private key of the first terminal device and the authorization key in the current phase, to obtain the updated authorization key, that is, an authorization key in a next phase.

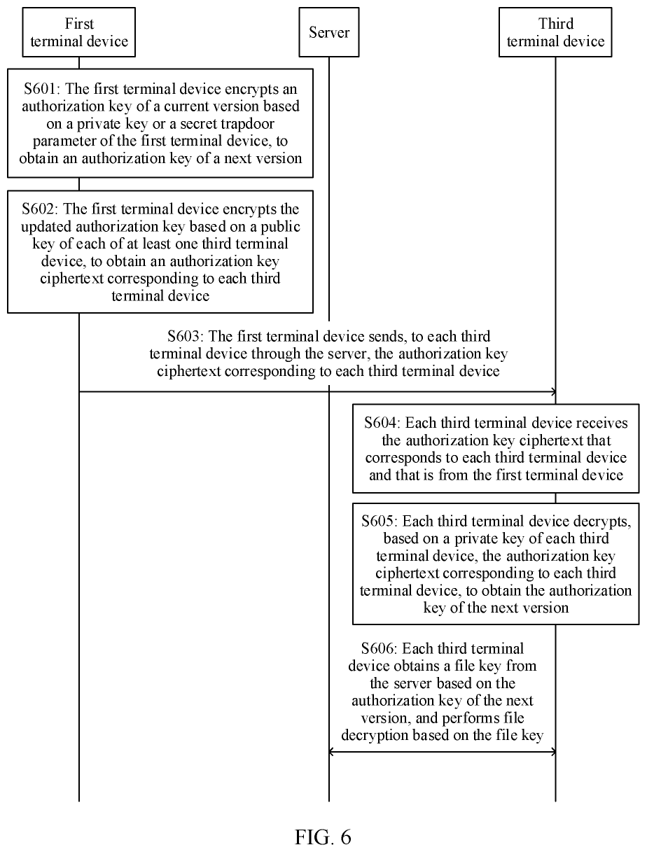

The following is described with reference to examples. FIG. 6 is a flowchart of an information processing method according to an embodiment of this application. As shown in FIG. 6, the method may further include the following steps.

S601: A first terminal device encrypts an authorization key of a current version based on a private key or a secret trapdoor parameter of the first terminal device, to obtain an authorization key of a next version.

The authorization key of the next version may be an authorization key that is in a next phase and that corresponds to the authorization key of the current version.

The first terminal device may encrypt the authorization key of the current version based on the private key of the first terminal device using a one-way trapdoor function, to obtain the authorization key of the next version. The one-way trapdoor function may be, for example, a deterministic one-way trapdoor function, such as a Rivest-Shamir-Adleman (RSA) function or a Rabin function.

The first terminal device may alternatively encrypt the authorization key of the current version based on the secret trapdoor parameter of the first terminal device using the one-way trapdoor function, to obtain the authorization key of the next version. The secret trapdoor parameter of the first terminal device may include, for example, the private key of the first terminal device and a modulus of the first terminal device.

It is assumed that if the first terminal device is a terminal device A, and an RSA function is used as an example, the terminal device A may encrypt the authorization key of the current version based on a private key SK_{A} of the terminal device A and a modulus n_{A} of the terminal device A using an RSA function shown in the following formula (1), to obtain the authorization key of the next version:

AKᵢ₊₁=AKᵢ^{SK}^{_{A}} mod n_{A}. formula (1)

AKᵢ₊₁ is the authorization key of the next version, that is, the authorization key that is in the next phase and that corresponds to the authorization key of the current version. mod is a modulo function. AKᵢ is the authorization key of the current version.

S602: The first terminal device encrypts the updated authorization key based on a public key of each of at least one third terminal device, to obtain an authorization key ciphertext corresponding to each third terminal device.

If the first terminal device updates the authorization key when revoking a sharing user, the at least one third terminal device may be a destination terminal device used for file sharing after the first terminal device revokes a terminal device. It is assumed that the terminal device A is a group owner terminal device. In a first phase, the terminal device A expects to share a file to a terminal device B, a terminal device C, and a terminal device D. That is, the at least one second terminal device may include the terminal device B, the terminal device C, and the terminal device D. In a second phase, the terminal device A revokes permission of the terminal device D. In this case, the at least one third terminal device may include the terminal device B and the terminal device C.

If the first terminal device updates the authorization key when a to-be-analyzed file changes, the at least one third terminal device is the at least one second terminal device.

S603: The first terminal device sends, to each third terminal device through a server, the authorization key ciphertext corresponding to each third terminal device.

The first terminal device may directly send, to each third terminal device, the authorization key ciphertext corresponding to each third terminal device, or may send, to each third terminal device through another intermediate device such as the server, the authorization key ciphertext corresponding to each third terminal device.

For example, the first terminal device may first send, to the server, the authorization key ciphertext corresponding to each third terminal device, and the server sends, to each third terminal device, the authorization key ciphertext corresponding to each third terminal device.

The first terminal device may send the obtained authorization key ciphertext corresponding to the at least one third terminal device to the server, and the server distributes the authorization key ciphertext, that is, sends, to each third terminal device, the authorization key ciphertext corresponding to each third terminal device. When each third terminal device goes online, the server may forward, to each third terminal device, the authorization key ciphertext corresponding to each third terminal device.

Because the authorization key ciphertext corresponding to each third terminal device is encrypted using the public key of each third terminal device, the authorization key ciphertext corresponding to each third terminal device may be decrypted only using a private key of each third terminal device. The server or another device does not have the private key of each third terminal device. Even if the server or another device receives the authorization key ciphertext corresponding to each third terminal device, the authorization key ciphertext corresponding to each third terminal device cannot be decrypted, and the authorization key of the next version cannot be obtained. Even if the revoked user equipment receives the authorization key ciphertext corresponding to each third terminal device, the user equipment cannot decrypt the authorization key ciphertext corresponding to each third terminal device, and then cannot obtain the authorization key of the next version. Therefore, the user equipment cannot access a file.

S604: Each third terminal device receives the authorization key ciphertext that corresponds to each third terminal device and that is from the first terminal device.

S605: Each third terminal device decrypts, based on the private key of each third terminal device, the authorization key ciphertext corresponding to each third terminal device, to obtain the authorization key of the next version.

Because the authorization key ciphertext corresponding to each third terminal device is encrypted using the public key of each third terminal device, the authorization key ciphertext corresponding to each third terminal device may be decrypted only using the private key of each third terminal device. However, the private key of each third terminal device is unknown to another device, and is known only to each third terminal device. Therefore, each third terminal device may decrypt, based on the private key of each third terminal device, the authorization key ciphertext corresponding to each third terminal device, to obtain the authorization key of the next version.

A device, for example, the revoked terminal device, outside the group in which the at least one third terminal device is located cannot receive the authorization key ciphertext that corresponds to the device outside the group in which the at least one third terminal device is located and that is sent by the first terminal device. Even if the device can obtain the authorization key ciphertext corresponding to the third terminal device, the device cannot obtain the authorization key of the next version because the device does not have the private key of the third terminal device and cannot decrypt the private key of the third terminal device.

S606: Each third terminal device obtains a file key from the server based on the authorization key of the next version, and performs file decryption based on the file key.

The third terminal device may obtain the file key from the server based on the authorization key of the next version, and decrypt, based on the file key, a to-be-shared file pre-stored on the server, thereby implementing file sharing between the first terminal device and the third terminal device.

In the information processing method, the first terminal device may update the authorization key based on the private key of the first terminal device, separately encrypt the updated authorization key based on the public key of the at least one third terminal device, to obtain the authorization key ciphertext corresponding to the at least one third terminal device, and transmit the authorization key ciphertext to each third terminal device such that each third terminal device may perform decryption based on the private key corresponding to each third terminal device, to obtain the updated authorization key, obtain the file key from the server, and perform file decryption based on the file key. In this way, when the first terminal device revokes a terminal device, the revoked terminal device cannot learn of the updated authorization key and cannot perform file decryption, thereby revoking decryption permission of the revoked terminal device and effectively ensuring data security.

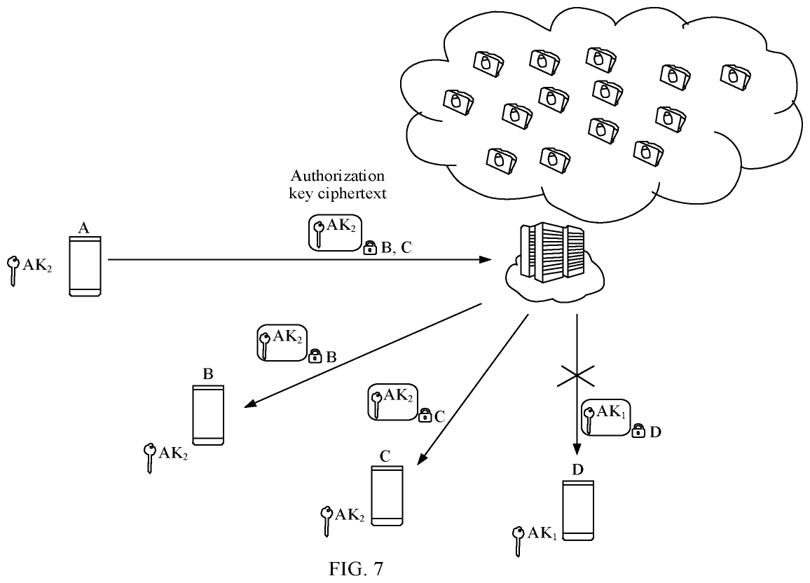

For example, FIG. 7 is a schematic diagram of an application scenario of an information processing method according to an embodiment of this application. As shown in FIG. 7, a terminal device A is a group owner terminal device, and in a first phase, the terminal device A expects to share a file to a terminal device B, a terminal device C, and a terminal device D. An authorization key in the first phase may be AK₁. In a second phase, the terminal device A revokes permission of the terminal device D, and the terminal device A may encrypt the authorization key AK₁ in the first phase using an RSA function shown in the following formula (2) based on SK_{A} of the terminal device A and a modulus n_{A} of the terminal device A, to obtain an authorization key AK₂ in the second phase:

AK₂=AK₁^{SK}^{_{A}} mod n_{A}. formula (2)

When obtaining the authorization key AK₂ in the second phase, the terminal device A may encrypt the authorization key AK₂ in the second phase based on a public key PK_{B} of the terminal device B, to obtain an authorization key ciphertext that is in the second phase and that corresponds to the terminal device B, and encrypt the authorization key AK₂ in the second phase based on a public key PK_{C} of the terminal device C, to obtain an authorization key ciphertext that is in the second phase and that corresponds to the terminal device C.

The terminal device A further sends, to a server, the authorization key ciphertext that is in the second phase and that corresponds to the terminal device B and the authorization key ciphertext that in the second phase and that corresponds to the terminal device C. The server may send, to the terminal device B when the terminal device B goes online, the authorization key ciphertext that is in the second phase and that corresponds to the terminal device B, and send, to the terminal device C when the terminal device C goes online, the authorization key ciphertext that is in the second phase and that corresponds to the terminal device C.

The terminal device B may decrypt, based on a private key SK_{B} of the terminal device B, the authorization key ciphertext that is in the second phase and that corresponds to the terminal device B, to obtain the authorization key AK₂ in the second phase.

The terminal device C may decrypt, based on a private key SK_{C} of the terminal device C, the authorization key ciphertext that is in the second phase and that corresponds to the terminal device C, to obtain the authorization key AK₂ in the second phase.

The terminal device D has been revoked by the terminal device A, and has only the authorization key in the first phase, but does not obtain the authorization key in the second phase that is sent by the terminal device A through the terminal device D. In addition, the terminal device D does not have a private key of the terminal device A. Therefore, the terminal device D cannot automatically derive the authorization key in the second phase. As a result, decryption permission of the terminal device D is revoked, thereby ensuring data security.

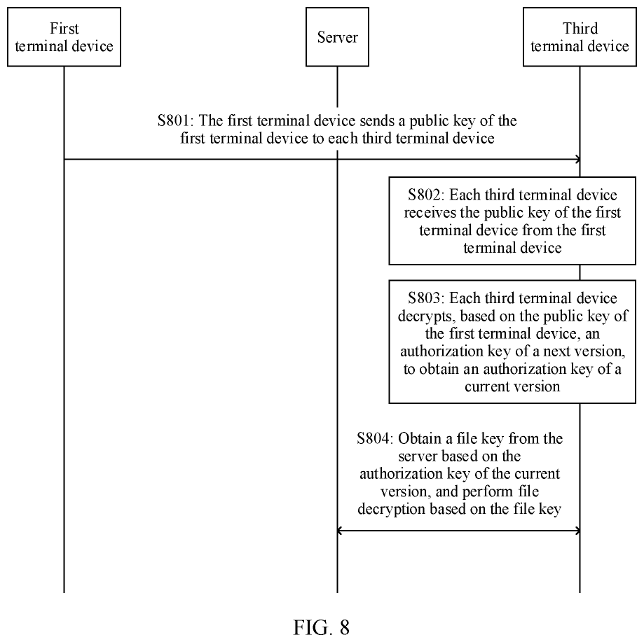

Based on the foregoing information processing method, an embodiment of this application may further provide an information processing method. FIG. 8 is a flowchart of an information processing method according to an embodiment of this application. As shown in FIG. 8, the information processing method may further include the following steps.

S801: A first terminal device sends a public key of the first terminal device to each third terminal device.

The first terminal device may directly send the public key of the first terminal device to each third terminal device, or may send the public key of the first terminal device to each third terminal device through another intermediate device such as a server.

For example, the first terminal device may first send the public key of the first terminal device to the server, and the server stores the public key of the first terminal device, and sends the public key of the first terminal device to each third terminal device.

The server may store a public key of a group owner terminal device in each phase.

S802: Each third terminal device receives the public key of the first terminal device from the first terminal device.

Each third terminal device may receive the public key of the first terminal device sent by the server from the first terminal device.

S803: Each third terminal device decrypts, based on the public key of the first terminal device, an authorization key of a next version, to obtain an authorization key of a current version.

S804: Obtain a file key from the server based on the authorization key of the current version, and perform file decryption based on the file key.

Each third terminal device may decrypt, based on the public key of the first terminal device using a one-way trapdoor function, the authorization key of the next version, to obtain the authorization key of the current version. The one-way trapdoor function may be, for example, a deterministic one-way trapdoor function, such as an RSA function or a Rabin function.

Alternatively, each third terminal device may decrypt, based on a public trapdoor parameter of the first terminal device using a one-way trapdoor function, the authorization key of the next version, to obtain the authorization key of the current version. The public trapdoor parameter of the first terminal device may include the public key and a modulus of the first terminal device.

It is assumed that if a fourth terminal device is a terminal device E, and an RSA function is used as an example, the fourth terminal device may decrypt the authorization key of the next version based on a public key PK_{A} of the terminal device A and a modulus n_{A} of the terminal device A using an RSA function shown in the following formula (3), to obtain the authorization key of the current version:

AKᵢ=AKᵢ₊₁^{PK}^{_{A}} mod n_{A}. formula (3)

AKᵢ₊₁ is the authorization key of the next version, that is, the authorization key that is in the next phase and that corresponds to the authorization key of the current version. mod is a modulo function. AKᵢ is the authorization key of the current version.

Especially for a newly added terminal device, according to the information processing method, the first terminal device may send, to each third terminal device, only the authorization key ciphertext corresponding to each third terminal device such that each third terminal device performs decryption using the private key of each third terminal device, to obtain the authorization key of the next version, the first terminal device does not need to send an authorization key in a previous phase to each third terminal device, and each third terminal device may decrypt the authorization key of the next version based on the public key of the first terminal device that is learned by each third terminal device, to derive the authorization key of the previous version. In this way, the information processing method can reduce traffic and key management and storage, and improve efficiency of key distribution and management.

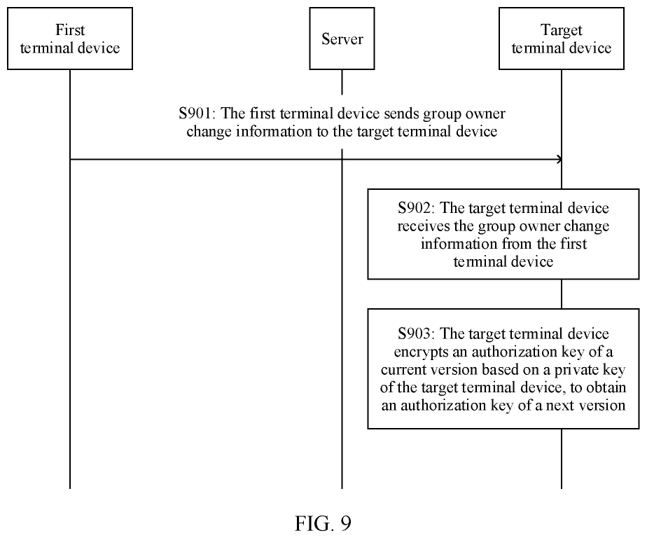

Based on the foregoing information processing method, an embodiment of this application may further provide an information processing method. FIG. 9 is a flowchart of an information processing method according to an embodiment of this application. As shown in FIG. 9, the information processing method may further include the following steps.

S901: A first terminal device sends group owner change information to a target terminal device through a server.

The first terminal device may be a current group owner terminal device. The target terminal device may be a destination group owner terminal device. The group owner terminal device may also be referred to as a group manager (GM). In this case, the first terminal device may be denoted as a GM 1, and the target terminal device may be denoted as a GM 2.

The first terminal device may send the group owner change information to the target terminal device through the server. That is, the first terminal device may send the group owner change information to the server, where the group owner change information includes information about the target terminal device such that the server forwards the group owner change information to the target terminal device. The server further records a group owner change record. The group owner change record may include at least information such as an identifier of a group owner terminal device in each phase, and a public key and a modulus of the group owner terminal device in each phase.

The first terminal device sends the group owner change information to the target terminal device such that the target terminal device confirms the group owner change information.

S902: The target terminal device receives the group owner change information from the first terminal device.

S903: The target terminal device encrypts an authorization key of a current version based on a private key of the target terminal device, to obtain an authorization key of a next version.

After receiving the group owner change information from the first terminal device, the target terminal device may determine to accept the first terminal device. When a group owner identity of the first terminal device is changed to the target terminal device, a next phase starts. Then, the target terminal device, used as the changed group owner terminal device, needs to update the authorization key, and may encrypt the current authorization key based on the private key of the target terminal device, to obtain the authorization key of the next version.

The authorization key of the current version may be an authorization key generated or updated by the first terminal device.

Alternatively, the target terminal device may encrypt the current authorization key based on a secret trapdoor parameter of the target terminal device using a one-way trapdoor function, to obtain the authorization key of the next version. The secret trapdoor parameter of the target terminal device may include the private key and a modulus of the target terminal device.

Therefore, when the target terminal device is used as the changed group owner terminal device, not all authorization keys in previous phases need to be re-calculated, and only a public key and a modulus of the group owner terminal device in each phase need to be recorded. As a result, update of authorization keys in all phases can be avoided, and a key ciphertext of a file that affects encryption also needs to be re-encrypted, greatly reducing an amount of communication and an amount of calculation.

For example, FIG. 10 is a schematic diagram of an application scenario of an information processing method according to an embodiment of this application. As shown in FIG. 10, a terminal device A is a group owner terminal device, and in a third phase, the terminal device A expects to change the group owner terminal device to a terminal device B. The terminal device A may send group owner update information to a server, and the server forwards the group owner change information to the terminal device B. After receiving the group owner update information, the terminal device B may be determined as the group owner terminal device, and may encrypt an authorization key AK₂ in a second phase using an RSA function shown in the following formula (4) based on SK_{B} of the terminal device B and a modulus n_{B} of the terminal device B, to obtain an authorization key AK₃ in a third phase:

AK₃=AK₂^{SK}^{_{B}} mod n_{B}. formula (4)

When obtaining the authorization key AK₃ in the third phase, the terminal device B may encrypt the authorization key AK₃ in the third phase based on a public key PK_{A} of the terminal device A, to obtain an authorization key ciphertext that is in the third phase and that corresponds to the terminal device A, and encrypt the authorization key AK₃ in the third phase based on a public key PK_{C} of the terminal device C, to obtain an authorization key ciphertext that is in the third phase and that corresponds to the terminal device C.

The terminal device B further sends, to the server, the authorization key ciphertext that is in the third phase and that corresponds to the terminal device A and the authorization key ciphertext that in the third phase and that corresponds to the terminal device C. The server may send, to the terminal device A when the terminal device A goes online, the authorization key ciphertext that is in the third phase and that corresponds to the terminal device B, and send, to the terminal device C when the terminal device C goes online, the authorization key ciphertext that is in the third phase and that corresponds to the terminal device C.

The terminal device A may decrypt, based on a private key SK_{A} of the terminal device A, the authorization key ciphertext that is in the third phase and that corresponds to the terminal device A, to obtain the authorization key AK₃ in the third phase.

The terminal device C may decrypt, based on a private key SK_{C} of the terminal device C, the authorization key ciphertext that is in the third phase and that corresponds to the terminal device C, to obtain the authorization key AK₃ in the third phase.

After the group owner terminal device is changed to the terminal device B, the terminal device B may update the authorization key based on a private key of the terminal device B, thereby effectively ensuring file access security after a group owner is updated, and ensuring data security.

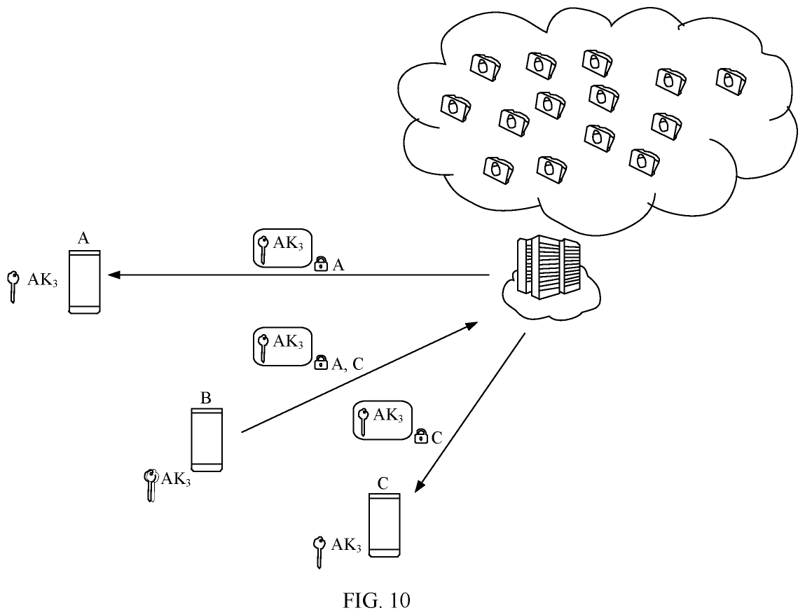

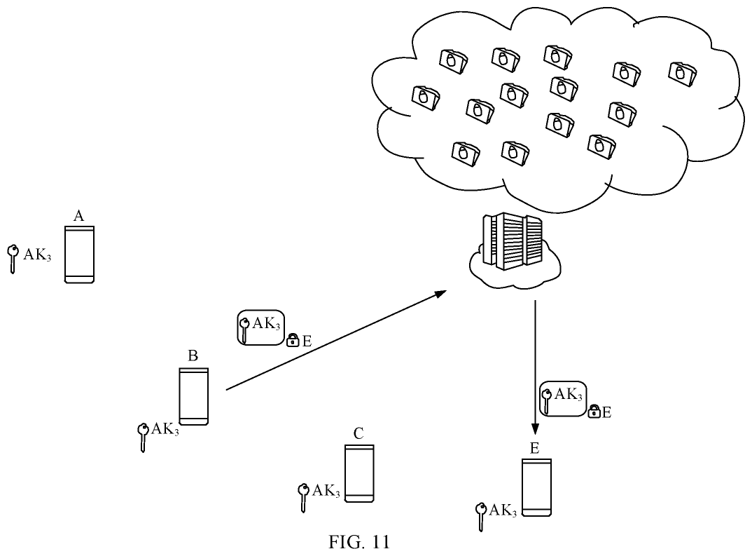

FIG. 11 is a schematic diagram of an application scenario of an information processing method according to an embodiment of this application. As shown in FIG. 11, a terminal device B is used as a group owner terminal device. In a third phase, the terminal device B expects to add a terminal device E to a group in which a user file is shared, and the terminal device B may decrypt, using a public key of the terminal device E, an authorization key in the third phase, to obtain an authorization key ciphertext corresponding to the terminal device E.

When receiving the authorization key ciphertext corresponding to the terminal device E, the terminal device E may decrypt, based on a private key of the terminal device E, the authorization key ciphertext corresponding to the terminal device E, to obtain the authorization key in the third phase.

The terminal device E may obtain, from a server, a public key PK_{B} and a modulus n_{B} of the terminal device B, and a public key PK_{A} and a modulus n_{A} of a terminal device A.

The terminal device E may decrypt a key AK₃ in the third phase based on the public key PK_{B} and the modulus n_{B} of the terminal device B using the following formula (5), to obtain a key AK₂ in a second phase:

AK₂=AK₃^{PK}^{_{B}} mod n_{B}. formula (5)

The terminal device E may decrypt the key AK₂ in the second phase based on the public key PK_{A} and the modulus n_{A} of the terminal device A using the following formula (6), to obtain a key AK₁ in a first phase:

AK₁=AK₂^{PK}^{_{A}} mod n_{A}. formula (6)

For a newly added terminal device, the group owner terminal device, that is, the terminal device B, may send, to the terminal device E, only the authorization key ciphertext of the terminal device E such that the terminal device E performs decryption using the private key of the terminal device E, to obtain the authorization key in the third phase. The terminal device B does not need to send an authorization key in a previous phase to the terminal device E. The terminal device E may also decrypt the authorization key based on a public key that is of the group owner terminal device in the previous phase and that is learned by the terminal device E, to derive the authorization key in the previous phase, for example, an authorization key in the second phase and an authorization key in the first phase. In this way, the information processing method can reduce traffic and key management and storage, and improve efficiency of key distribution and management.

In another implementation, as the group owner terminal device, the first terminal device may determine, from a preset first database, an authorization key of a next version as an authorization key in a next phase.

The following is described with reference to examples. FIG. 12 is a flowchart of an information processing method according to an embodiment of this application. As shown in FIG. 12, the method may further include the following steps.

S1201: A first terminal device determines, from a preset first database, an authorization key of a next version of an authorization key of a current version, where the first database includes authorization keys of a plurality of versions of the first terminal device.

The first database may be a database of authorization keys of the first terminal device, and includes authorization keys of a plurality of versions. All the authorization keys of the plurality of versions may be obtained by the first terminal device.

In this implementation, the first terminal device, that is, a group owner terminal device, can update the authorization key without calculation, but determines an authorization key of a next version from the first database to update the authorization key.

Optionally, before determining, by a first terminal device, from a preset first database, an authorization key of a next version of an authorization key of a current version in S1201 in the information processing method, the method may further include obtaining, by the first terminal device, the authorization keys of the plurality of versions in the first database based on a preset first random number using a preset first one-way trapdoor function.

The first random number may be randomly selected by the first terminal device. Therefore, the first random number may also be referred to as a private key of the first terminal device. The first terminal device has a “trapdoor” for updating a version authorization key, and another device cannot learn of the first random number, and therefore cannot calculate the authorization key of the next version.

The preset first one-way trapdoor function may be a hash chain function, which is also referred to as a hash function, for example, may be any one of a message-digest algorithm 5 (MD5) function, a Secure Hash Algorithm (SHA) function, and the like.

Optionally, the first terminal device may use the first random number as an authorization key of an n^{th} version of the first terminal device, where n is an integer greater than or equal to 2, and the first terminal device may obtain an authorization key of an (n−1)^{th} version of the first terminal device based on the authorization key of the n^{th} version using the first one-way trapdoor function, until an authorization key of the first version of the first terminal device is obtained. In this way, the first terminal device can obtain authorization keys, that is, the authorization keys in the first database, of n versions of the first terminal device.

If the first terminal device is a terminal device A, the first random number may be denoted as SK_{A}, and the terminal device A may use the first random number SK_{A} as the authorization key AK_{nA} of the n^{th} version of the terminal device A and obtain the authorization key AK_{(i-1)A} of the (n−1)^{th} version of the terminal device A using an SHA function shown in the following formula (7). i may be any integer greater than or equal to 2 and less than n:

AK_{(i-1)A}=SHA(AK_{iA}). formula (7)

That is, in the first database, an authorization key of an (i−1)^{th} version of the terminal device A may be obtained using a hash value of an authorization key of an i^{th} version of the terminal device A.

After all the authorization keys of the plurality of versions in the first database of the first terminal device are used, the first terminal device may reselect a random number, and obtain the authorization keys of the plurality of versions of the first terminal device using the preset first one-way trapdoor function, to update the first database. For example, the first terminal device may be reset as a new group owner terminal device by executing a process of changing the group owner terminal device. The reset first terminal device reselects a random number, and obtains the authorization keys of the plurality of versions of the first terminal device using the preset first one-way trapdoor function.

S1202: The first terminal device encrypts the authorization key of the next version based on a public key of each of at least one fourth terminal device, to obtain an authorization key ciphertext corresponding to each fourth terminal device.

The at least one fourth terminal device is a destination terminal device used for file sharing after the first terminal device revokes a terminal device.

S1203: The first terminal device sends, to each fourth terminal device through a server, the authorization key ciphertext corresponding to each fourth terminal device.

For a specific description of S1203, refer to S603. Details are not described herein again.

S1204: Each fourth terminal device receives the authorization key ciphertext that corresponds to each fourth terminal device and that is sent by the first terminal device.

For a specific description of S1204, refer to S604. Details are not described herein again.

S1205: Each fourth terminal device decrypts, based on a private key of each fourth terminal device, the authorization key ciphertext corresponding to each fourth terminal device, to obtain the authorization key of the next version.

For a specific description of S1205, refer to S605. Details are not described herein again.

S1206: Each fourth terminal device obtains a file key from the server based on the authorization key of the next version, and performs file decryption based on the file key.

For a specific description of S1206, refer to S606. Details are not described herein again.

Optionally, when obtaining the authorization key of the next version, each fourth terminal device may further obtain the authorization key of the current version based on the authorization key of the next version using the preset first one-way trapdoor function, and performs file decryption based on the authorization key of the current version.

The authorization key of the (n−1)^{th} version in the first database is obtained based on the authorization key of the n^{th} version using the preset first one-way trapdoor function. Therefore, each fourth terminal device uses the preset first one-way trapdoor function based on the authorization key of the next version, to obtain the authorization key of the current version. For example, each third terminal device may obtain the authorization key of the current version based on a hash value of the authorization key of the next version.

In the information processing method, the first terminal device may determine, from the preset first database, the authorization key of the next version of the authorization key of the current version, to update the authorization key, separately encrypt the authorization key of the next version based on the public key of the at least one fourth terminal device, to obtain the authorization key ciphertext corresponding to the at least one fourth terminal device, and transmit the authorization key ciphertext to each fourth terminal device such that each fourth terminal device can perform decryption based on the private key corresponding to the fourth terminal device, to obtain the updated authorization key, and then perform file decryption. In this way, when the first terminal device revokes a terminal device, the revoked terminal device cannot learn of the updated authorization key and cannot perform file decryption, thereby revoking decryption permission of the revoked terminal device and effectively ensuring data security.

For example, the terminal device A is the group owner terminal device, and in a first phase, the terminal device A expects to share a file to a terminal device B, a terminal device C, and a terminal device D. An authorization key in the first phase may be AK₁. In a second phase, the terminal device A revokes permission of the terminal device D, and the terminal device A may select, based on AK₁, an authorization key of a next version of AK₁ from a database of the terminal device A as an authorization key AK₂ in the second phase.

When obtaining the authorization key AK₂ in the second phase, the terminal device A may encrypt the authorization key AK₂ in the second phase based on a public key PK_{B} of the terminal device B, to obtain an authorization key ciphertext that is in the second phase and that corresponds to the terminal device B, and encrypt the authorization key AK₂ in the second phase based on a public key PK_{C} of the terminal device C, to obtain an authorization key ciphertext that is in the second phase and that corresponds to the terminal device C.

The terminal device A further sends, to a server, the authorization key ciphertext that is in the second phase and that corresponds to the terminal device B and the authorization key ciphertext that in the second phase and that corresponds to the terminal device C. The server may send, to the terminal device B when the terminal device B goes online, the authorization key ciphertext that is in the second phase and that corresponds to the terminal device B, and send, to the terminal device C when the terminal device C goes online, the authorization key ciphertext that is in the second phase and that corresponds to the terminal device C.

The terminal device B may decrypt, based on a private key SK_{B} of the terminal device B, the authorization key ciphertext that is in the second phase and that corresponds to the terminal device B, to obtain the authorization key AK₂ in the second phase.

The terminal device C may decrypt, based on a private key SK_{C} of the terminal device C, the authorization key ciphertext that is in the second phase and that corresponds to the terminal device C, to obtain the authorization key AK₂ in the second phase.

The terminal device D has been revoked by the terminal device A, and has only the authorization key in the first phase, but does not obtain the authorization key in the second phase that is sent by the terminal device A through the terminal device D. In addition, the terminal device D does not have a private key of the terminal device A. Therefore, the terminal device D cannot automatically derive the authorization key in the second phase. As a result, decryption permission of the terminal device D is revoked, thereby ensuring data security.

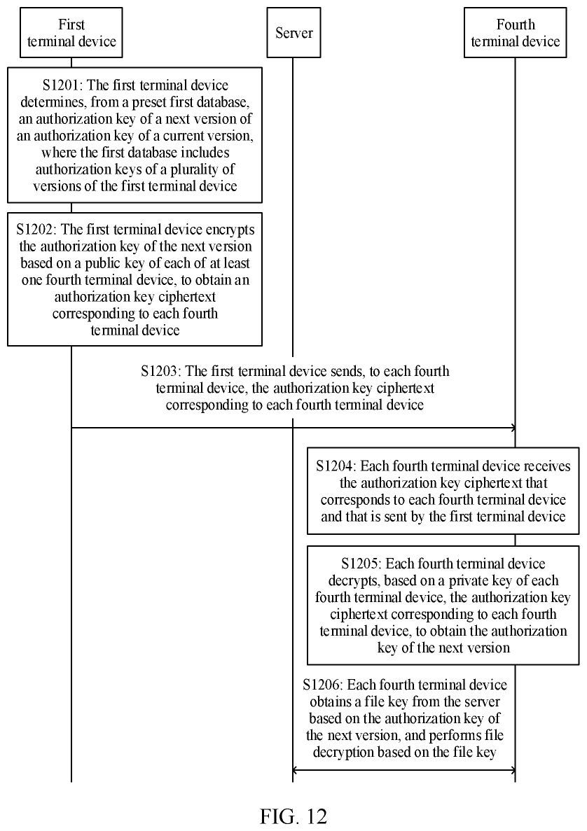

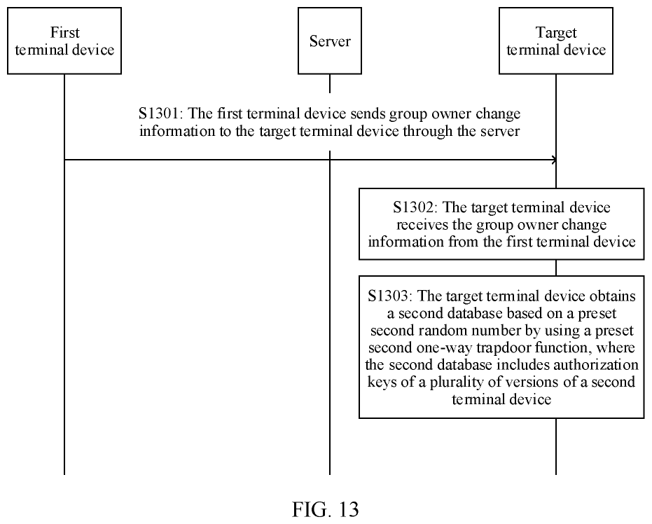

Based on the foregoing information processing method, an embodiment of this application may further provide an information processing method. FIG. 13 is a flowchart of an information processing method according to an embodiment of this application. As shown in FIG. 13, the information processing method may further include the following steps.

S1301: A first terminal device sends group owner change information to a target terminal device through a server.

For a specific description of S1301, refer to S901. Details are not described herein again.

S1302: The target terminal device receives the group owner change information from the first terminal device.

For a specific description of S1302, refer to S902. Details are not described herein again.

S1303: The target terminal device obtains a second database based on a preset second random number using a preset second one-way trapdoor function, where the second database includes authorization keys of a plurality of versions of a second terminal device.

The second random number may be randomly selected by the target terminal device. Therefore, the second random number may also be referred to as a private key of the second terminal device. The second terminal device has a “trapdoor” for updating a version authorization key, and another device cannot learn of the second random number, and therefore cannot calculate the authorization key of the next version.

The preset second one-way trapdoor function may be a hash chain function, also referred to as a hash function, and may be, for example, any one of an MD5 function, an SHA function, or the like.

Optionally, the target terminal device may use the second random number as an authorization key of an n^{th} version of the target terminal device, where n is an integer greater than or equal to 2, and the target terminal device may obtain an authorization key of an (n−1)^{th} version of the target terminal device based on the authorization key of the n^{th} version using the second one-way trapdoor function, until an authorization key of the first version of the target terminal device is obtained. In this way, the target terminal device can obtain authorization keys, that is, the authorization keys in the second database, of n versions of the target terminal device.

If the target terminal device is a terminal device B, the second random number may be denoted as SK_{B}, and the terminal device B may use the second random number SK_{B} as the authorization key AK_{nB} of the n^{th} version of the terminal device B and obtain the authorization key AK_{(i-1)B} of the (n−1)^{th} version of the terminal device B using an SHA function shown in the following formula (8). i may be any integer greater than or equal to 2 and less than n:

AK_{(i-1)B}=SHA(AK_{iB}). formula (8)

That is, in the first database, an authorization key of an (i−1)^{th} version of the terminal device B may be obtained using a hash value of an authorization key of an i^{th} version of the terminal device B.

If the terminal device A changes a group owner to the terminal device B in a second phase, the current authorization key may be AK_{2A}. The terminal device B may further encrypt the current authorization key AK_{2A} using the authorization key of the first version in the second database, that is, the authorization key AK_{1B} of the first version of the terminal device B, and then send the encrypted current authorization key to the server such that the server records the encrypted current authorization key AK_{2A} to a version change history of the authorization key.

Therefore, when the target terminal device is used as the changed group owner terminal device, the target terminal device can obtain authorization keys in previous phases based on the updated authorization key with reference to the version change history in the server, without recalculating all the authorization keys in the previous phases. As a result, update of the authorization keys in all the phases is avoided, and a key ciphertext of a file that affects encryption also needs to be re-encrypted, greatly reducing an amount of communication and an amount of calculation.

For example, the terminal device A is the group owner terminal device, and in a third phase, the terminal device A expects to change the group owner terminal device to the terminal device B. The terminal device A may send group owner update information to the server, and the server forwards the group owner change information to the terminal device B. After receiving the group owner update information, the terminal device B may be determined as the group owner terminal device, and may obtain the n authorization keys of the terminal device B based on a random number, such as SK_{B}, of the terminal device B using the SHA function shown in the foregoing formula (8), and the authorization key AK_{1B} of the first version of the terminal device B is used as the authorization key AK₃ in the third phase.

When obtaining the authorization key AK₃ in the third phase, the terminal device B may encrypt the authorization key AK₃ in the third phase based on a public key PK_{A} of the terminal device A, to obtain an authorization key ciphertext that is in the third phase and that corresponds to the terminal device A, and encrypt the authorization key AK₃ in the third phase based on a public key PK_{C} of the terminal device C, to obtain an authorization key ciphertext that is in the third phase and that corresponds to the terminal device C.

The terminal device B further sends, to the server, the authorization key ciphertext that is in the third phase and that corresponds to the terminal device A and the authorization key ciphertext that in the third phase and that corresponds to the terminal device C. The server may send, to the terminal device A when the terminal device A goes online, the authorization key ciphertext that is in the third phase and that corresponds to the terminal device B, and send, to the terminal device C when the terminal device C goes online, the authorization key ciphertext that is in the third phase and that corresponds to the terminal device C.

The terminal device A may decrypt, based on a private key SK_{A} of the terminal device A, the authorization key ciphertext that is in the third phase and that corresponds to the terminal device A, to obtain the authorization key AK₃ in the third phase.

The terminal device C may decrypt, based on a private key SK_{C} of the terminal device C, the authorization key ciphertext that is in the third phase and that corresponds to the terminal device C, to obtain the authorization key AK₃ in the third phase.

After the group owner terminal device is changed to the terminal device B, the terminal device B may update the authorization key based on a private key of the terminal device B, thereby effectively ensuring file access security after a group owner is updated, and ensuring data security.

The terminal device B is used as the group owner terminal device. In the third phase, if the terminal device B expects to add a terminal device E to a group in which a user file is shared, the terminal device B may decrypt, using a public key of the terminal device E, the authorization key in the third phase, to obtain an authorization key ciphertext corresponding to the terminal device E.

When receiving the authorization key ciphertext corresponding to the terminal device E, the terminal device E may decrypt, based on a private key of the terminal device E, the authorization key ciphertext corresponding to the terminal device E, to obtain the authorization key in the third phase.

If a new terminal device, such as the terminal device E, wants to view a file of a historical version, the terminal device E needs to calculate an authorization key of the historical version based on the authorization key of the third version, and then performs file decryption. The terminal device E needs to determine whether an encrypted version authorization key between an authorization key of a to-be-decrypted version and an authorization key in a current phase, for example, the authorization key in the third phase, is recorded in the server. If no, the terminal device E may calculate the authorization key of the to-be-decrypted version based on the authorization key in the current phase, for example, the authorization key in the third phase, using a hash function. If yes, the terminal device E finds the encrypted version authorization key from the server, and the terminal device E may obtain an authorization key of the first version of the current group owner terminal device using a hash function, then decrypt the encrypted version authorization key in the historical record based on the authorization key of the first version of the current group owner terminal device, then obtain an authorization key of each version of the current group owner terminal device using the encrypted version authorization key as a base point and using a hash function, until the authorization key of the to-be-decrypted version is obtained.

In an implementation, the first terminal device used as the group owner terminal device may update a key based on a secrete trapdoor parameter of the first terminal device and the authorization key in the current phase, to obtain the updated authorization key, that is, an authorization key in a next phase.

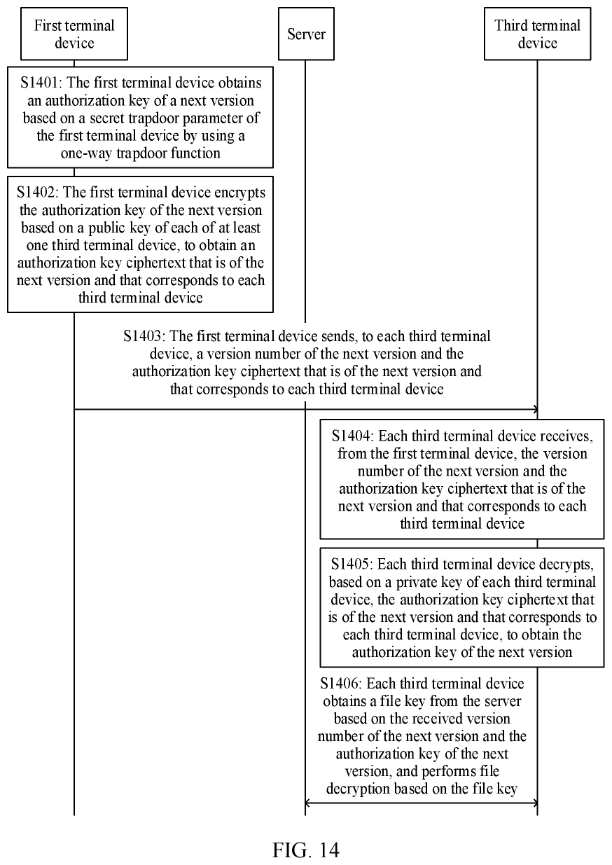

FIG. 14 is a flowchart of an information processing method according to an embodiment of this application. The information processing method shown in FIG. 14 is described using an example in which an authorization key is updated in a scenario in which a terminal device is revoked. As shown in FIG. 14, the method may include the following steps.

S1401: A first terminal device obtains an authorization key of a next version based on a secret trapdoor parameter of the first terminal device using a one-way trapdoor function.

The secret trapdoor parameter of the first terminal device may be denoted as C_{GM1}, and the authorization key of the next version may be, for example, _AK_{V+1}.

S1402: The first terminal device encrypts the authorization key of the next version based on a public key of each of at least one third terminal device, to obtain an authorization key ciphertext that is of the next version and that corresponds to each third terminal device.

The at least one third terminal device may be a terminal device other than the to-be-revoked terminal device in member terminal devices.

The first terminal device may obtain public keys of all the member terminal devices from metadata of a group. The metadata of the group may be stored in the first terminal device, or may be stored on a server. If the metadata of the group is on the server, the first terminal device further needs to obtain the metadata of the group from the server.

If the revoked terminal device is a member terminal device U2, at least one second terminal device may be a terminal device other than the member terminal device U2, that is, does not include the member terminal device U2.

S1403: The first terminal device sends, to each third terminal device through the server, a version number of the next version and the authorization key ciphertext that is of the next version and corresponds to each third terminal device.

The first terminal device may send, to the server, the authorization key ciphertext that is of the next version and that corresponds to each third terminal device. The server receives the authorization key ciphertext that is of the next version, that corresponds to each third terminal device, and that is sent by the first terminal device.

The server may further update a version number from V to V+1, and add a public trapdoor parameter P_{GM1} of the first terminal device to a version history.

S1404: Each third terminal device receives, from the first terminal device, the version number of the next version and the authorization key ciphertext that is of the next version and that corresponds to each third terminal device.

S1405: Each third terminal device decrypts, based on a private key of each third terminal device, the authorization key ciphertext that is of the next version and that corresponds to each third terminal device, to obtain the authorization key of the next version.

S1406: Each third terminal device obtains a file key from the server based on the received version number of the next version and the authorization key of the next version, and performs file decryption based on the file key.

The server may further send update success information to the first terminal device, and update the metadata of the group. The metadata of the group further includes information about the member terminal device and version information.

The first terminal device may further update the metadata of the group that is stored in the first terminal device, and after updating the metadata of the group, send the metadata of the group to the server, and the server stores the metadata of the group.

In the information processing method, the first terminal device may update the authorization key based on the secret trapdoor parameter of the first terminal device, separately encrypt the updated authorization key based on the public key of the at least one third terminal device, to obtain the authorization key ciphertext corresponding to the at least one third terminal device, and transmit the authorization key ciphertext to each third terminal device such that each third terminal device may perform decryption based on the private key corresponding to each third terminal device, to obtain the updated authorization key, and then perform file decryption. In this way, when the first terminal device revokes a terminal device, the revoked terminal device cannot learn of the updated authorization key and cannot perform file decryption, thereby revoking decryption permission of the revoked terminal device and effectively ensuring data security.

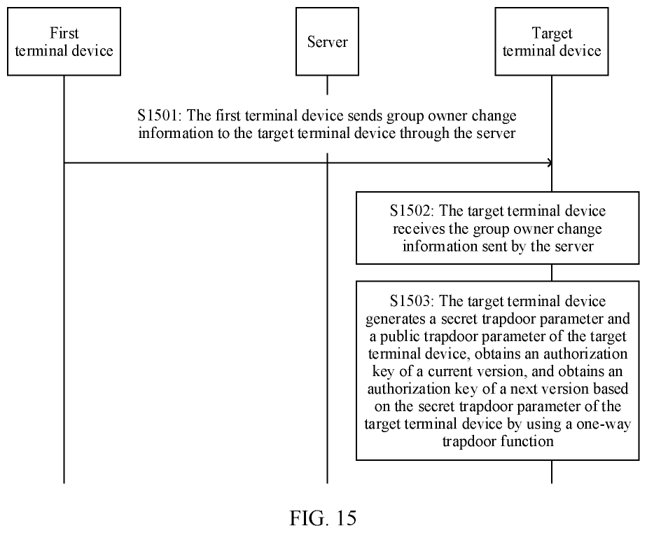

FIG. 15 is a flowchart of an information processing method according to an embodiment of this application. The information processing method shown in FIG. 15 is described using an example in which an authorization key is updated in a scenario in which a group owner terminal device is changed. As shown in FIG. 15, the method may further include the following steps.

S1501: A first terminal device sends group owner change information to a target terminal device through a server.

The first terminal device may send a group owner change request to the server. After receiving the group owner change request, the server may first switch an identity of a group owner from the first terminal device to the target terminal device, and send the group owner change information to the target terminal device such that the target terminal device confirms the identity of the group owner. The group owner change request may include the group owner change information, for example, information about the target terminal device.

S1502: The target terminal device receives the group owner change information sent by the server.

S1503: The target terminal device generates a secret trapdoor parameter and a public trapdoor parameter of the target terminal device, obtains an authorization key of a current version, and obtains an authorization key of a next version based on the secret trapdoor parameter of the target terminal device using a one-way trapdoor function.

The target terminal device may be a GM 2. The secret trapdoor parameter of the target terminal device may be C_{GM2}, and the public trapdoor parameter of the target terminal device may be P_{GM2}. The authorization key of the next version may be AK_{V+1}.

The target terminal device further sends a version number of the next version and the public trapdoor parameter of the target terminal device to the server.

The server receives the version number of the next version and the public trapdoor parameter of the target terminal device that are sent by the target terminal device.

The server may add the received version number V+1 of the next version and the received public trapdoor parameter P_{GM2} of the target terminal device to the version history.

The target terminal device further obtains a public key of the member terminal device in the group, and the target terminal device encrypts the authorization key of the next version based on a public key of each member terminal device in the group, to obtain an authorization key ciphertext that is of the next version and that corresponds to each member terminal device.

The target terminal device may obtain public keys of all the member terminal devices from the metadata of the group. The target terminal device may obtain the metadata of the group from the server.

The target terminal device further sends, to the server, the authorization key ciphertext that is of the next version and that corresponds to each member terminal device, and the server sends, to each member terminal device, the version number of the next version and the authorization key ciphertext that is of the next version and that corresponds to each member terminal device.

The server further updates the metadata of the group. The metadata of the group may further include information about the changed group owner terminal device, and a public trapdoor parameter, version information, and the like of the changed group owner terminal device.

Each member terminal device performs file decryption based on the received version number of the next version and the received authorization key ciphertext that is of the next version and that corresponds to each member terminal device.

The first terminal device and the target terminal device further separately update the metadata that is of the group and that is stored by the first terminal device and the target terminal device.

According to the information processing method, when the group owner terminal device is changed, the changed group owner terminal device may update the authorization key, thereby ensuring file security. In addition, after the group owner terminal device is changed, the changed group owner terminal device does not need to recalculate the authorization key, and each member terminal device may also derive a key with reference to a public trapdoor parameter of a group owner terminal device corresponding to each version in the version history, to obtain an authorization key of each historical version. In this way, the information processing method can reduce traffic and key management and storage, and improve efficiency of key distribution and management.

Based on the information processing method shown in FIG. 14 or FIG. 15, an embodiment of this application may further provide an example in which a member terminal device queries a file. If a member terminal device U1 needs to query a file F2 in a sharing folder, the member terminal device U1 may download the file F2 from the server, and obtain a version number V_{F2} of the file F2. The member terminal device U1 further needs to obtain the version number V_{current} of the authorization key of the current version.

If V_{F2}=V_{current}, the member terminal device U1 may decrypt the file F2 based on the authorization key AK_{current} of the current version.

If V_{F2}<V_{current}, the member terminal device U1 may obtain the version history from the server. The version history may include a public trapdoor parameter of a group owner terminal device corresponding to each version, for example, {(v₁, P_{GM1}), (vn, P_{GMn})}. The member terminal device U1 may obtain an authorization key of a previous version of the current version based on the authorization key AK_{current} of the current version and the public trapdoor parameter P_{GMX} that is of the group owner terminal device and that corresponds to the current version using the one-way trapdoor function, repeat execution, and when the obtained version number of the authorization key is the same as the version number V_{F2} of the file F2, decrypt the file F2 based on the authorization key of the same version number.

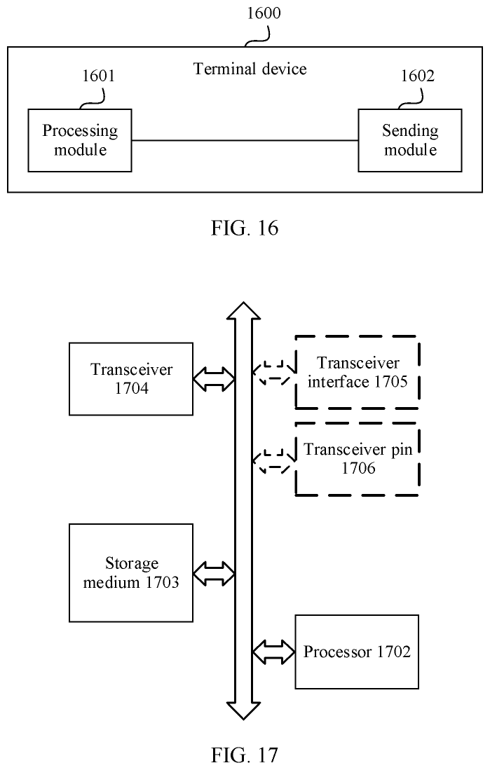

An embodiment of this application may further provide a terminal device. The terminal device may be used as a first terminal device, and has any function of the first terminal device in any method in FIG. 2 to FIG. 15. FIG. 16 is a schematic structural diagram of a terminal device according to an embodiment of this application. As shown in FIG. 16, the terminal device 1600 may include a processing module 1601 configured to encrypt an authorization key of a current version based on a public key of each of at least one second terminal device, to obtain an authorization key ciphertext corresponding to each second terminal device, and a sending module 1602 configured to send, to each second terminal device through a server, the authorization key ciphertext corresponding to each second terminal device, where the authorization key ciphertext corresponding to each second terminal device is used to enable each second terminal device to decrypt, based on a private key of each second terminal device, the authorization key ciphertext corresponding to each second terminal device, to obtain the authorization key of the current version, obtain a file key from the server based on the authorization key of the current version, and perform file decryption based on the file key.

It should be understood that the terminal device 1600 has any function of the first terminal device in any method in FIG. 2 to FIG. 15. For the any function, refer to any method in FIG. 2 to FIG. 15. Details are not described herein again.

The terminal device provided in the foregoing embodiment of this application may be implemented in a plurality of product forms. For example, the terminal device may be configured as a general-purpose processing system. For example, the terminal device may be implemented using a general bus architecture. For example, the terminal device may be implemented by an ASIC. The following provides several possible product forms of the terminal device in the embodiments of this application. It should be understood that the following is merely an example, and the possible product forms in the embodiments of this application are not limited thereto.

FIG. 17 is a structural diagram of a possible product form of a terminal device according to an embodiment of this application.

As a possible product form, the terminal device may be implemented by a device, and the terminal device includes a processor 1702 and a transceiver 1704. Optionally, the terminal device may further include a storage medium 1703.

As another possible product form, the terminal device is also implemented using a general-purpose processor, that is, implemented using a commonly known chip. The general-purpose processor includes a processor 1702 and a transceiver interface 1705/transceiver pin 1706. Optionally, the general-purpose processor may further include a storage medium 1703.

As another possible product form, the terminal device may alternatively be implemented using the following: one or more field-programmable gate arrays (FPGAs), a programmable logic device (PLD), a controller, a state machine, gate logic, a discrete hardware component, any other suitable circuit, or any combination of circuits that can perform various functions described in this application.

Optionally, an embodiment of this application further provides a computer-readable storage medium. The computer-readable storage medium may include an instruction. When the instruction is run on a computer, the computer is enabled to perform any information processing method performed by the first terminal device in FIG. 2 to FIG. 5 in the foregoing embodiments.

Optionally, an embodiment of this application further provides a computer program product including an instruction. When the computer program product is run on a computer, the computer is enabled to perform any information processing method performed by the first terminal device in FIG. 2 to FIG. 5 in the foregoing embodiments.

Functions of the computer program product may be implemented using hardware or software. When the functions are implemented using software, the functions may be stored in a computer-readable medium or transmitted as one or more instructions or code in the computer-readable storage medium.

The terminal device, the computer-readable storage medium, and the computer program product in the embodiments of this application may perform any information transmission method performed by the first terminal device in FIG. 2 to FIG. 15. For a specific implementation process and beneficial effects thereof, refer to the foregoing descriptions. Details are not described herein again.

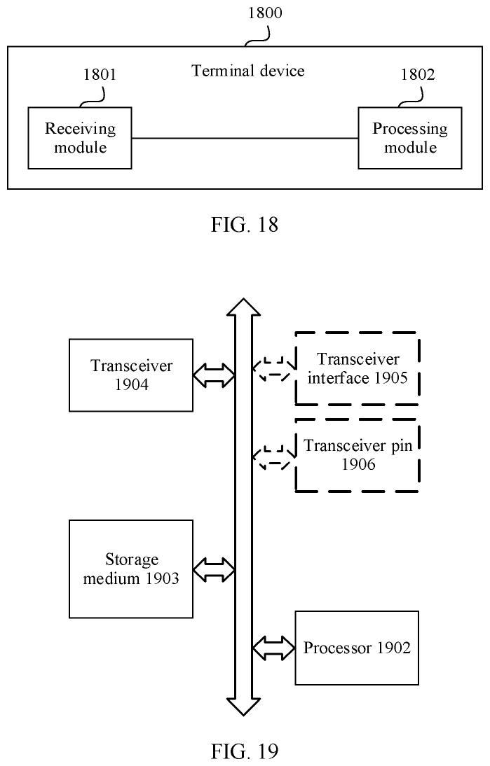

An embodiment of this application may further provide a terminal device. The terminal device may be used as a second terminal device, and has any function of the second terminal device in any method in FIG. 2 to FIG. 15. FIG. 18 is a schematic structural diagram of a terminal device according to an embodiment of this application. As shown in FIG. 18, the terminal device 1800 may include a receiving module 1801 configured to receive an authorization key ciphertext that corresponds to the second terminal device and that is sent by a first terminal device through a server, where the authorization key ciphertext corresponding to the second terminal device is a ciphertext obtained by encrypting, by the first terminal device, an authorization key of a current version based on a public key of the second terminal device, and a processing module 1802 configured to decrypt, based on a private key of the second terminal device, the authorization key ciphertext corresponding to the second terminal device, to obtain the authorization key of the current version, obtaining a file key from the server based on the authorization key of the current version, and performing file decryption based on the file key.

It should be understood that the terminal device 1800 has any function of the second terminal device in any method in FIG. 2 to FIG. 15. For the any function, refer to any method in FIG. 2 to FIG. 15. Details are not described herein again.

The terminal device provided in the foregoing embodiment of this application may be implemented in a plurality of product forms. For example, the terminal device may be configured as a general-purpose processing system. For example, the terminal device may be implemented using a general bus architecture. For example, the terminal device may be implemented by an ASIC. The following provides several possible product forms of the terminal device in the embodiments of this application. It should be understood that the following is merely an example, and the possible product forms in the embodiments of this application are not limited thereto.

FIG. 19 is a structural diagram of a possible product form of a terminal device according to an embodiment of this application.

As a possible product form, the terminal device may be implemented by a device, and the terminal device includes a processor 1902 and a transceiver 1904. Optionally, the terminal device may further include a storage medium 1903.

As another possible product form, the terminal device is also implemented using a general-purpose processor, that is, implemented using a commonly known chip. The general-purpose processor includes a processor 1902 and a transceiver interface 1905/transceiver pin 1906. Optionally, the general-purpose processor may further include a storage medium 1903.

As another possible product form, the terminal device may alternatively be implemented using the following: one or more FPGAs, a PLD, a controller, a state machine, gate logic, a discrete hardware component, any other suitable circuit, or any combination of circuits that can perform various functions described in this application.

Optionally, an embodiment of this application further provides a computer-readable storage medium. The computer-readable storage medium may include an instruction. When the instruction is run on a computer, the computer is enabled to perform any information processing method performed by the second terminal device in FIG. 2 to FIG. 5 in the foregoing embodiments.

Optionally, an embodiment of this application further provides a computer program product including an instruction. When the computer program product is run on a computer, the computer is enabled to perform any information processing method performed by the second terminal device in FIG. 2 to FIG. 5 in the foregoing embodiments.

Functions of the computer program product may be implemented using hardware or software. When the functions are implemented using software, the functions may be stored in a computer-readable medium or transmitted as one or more instructions or code in the computer-readable storage medium.

The terminal device, the computer-readable storage medium, and the computer program product in the embodiments of this application may perform any information transmission method performed by the second terminal device in FIG. 2 to FIG. 15. For a specific implementation process and beneficial effects thereof, refer to the foregoing descriptions. Details are not described herein again.

An embodiment of this application may further provide a network system. The network system may include a first terminal device, a server, and at least one second terminal device. The first terminal device is connected to the server, and the server is further connected to each second terminal device. The first terminal device may be the terminal device in any one of FIG. 16 or FIG. 17, and each second terminal device may be the terminal device in either of FIG. 18 or FIG. 19.

The network system may be a cloud storage system. The system may implement the information processing method in any one of the foregoing embodiments. For a specific implementation process and beneficial effects of the system, refer to the foregoing descriptions. Details are not described herein again.

It should be understood that the term “and/or” in this specification describes only an association relationship for describing associated objects and represents that three relationships may exist. For example, A and/or B may represent the following three cases: only A exists, both A and B exist, and only B exists. In addition, the character “/” in this specification usually indicates an “or” relationship between the associated objects.

It should be understood that in the embodiments of this application, “B corresponding to A” indicates that B is associated with A, and that B may be determined based on A. However, it should further be understood that determining B based on A does not mean that B is determined based on only A. B may alternatively be determined based on A and/or other information.

In this application, “at least one” means one or more, and “a plurality of” means two or more. The term “and/or” describes an association relationship between associated objects and may indicate three relationships. For example, A and/or B may indicate the following cases: only A exists, both A and B exist, and only B exists, where A and B may be singular or plural. The character “I” generally indicates an “or” relationship between the associated objects. “At least one of the following items (pieces)” or a similar expression means any combination of the items, including any combination of singular items (pieces) or plural items (pieces). For example, at least one item (piece) of a, b, or c may represent: a, b, c, a-b, a-c, b-c, or a-b-c, where a, b, and c may be singular or plural.

A person of ordinary skill in the art may be aware that, in combination with the examples described in the embodiments disclosed in this specification, units and algorithm steps may be implemented by electronic hardware, computer software, or a combination thereof. To clearly describe interchangeability between the hardware and the software, the foregoing has generally described compositions and steps of each example based on functions. Whether the functions are performed by hardware or software depends on particular applications and design constraint conditions of the technical solutions. A person skilled in the art may use a different method to implement the described function for each particular application, but it should not be considered that the implementation goes beyond the scope of this application.

It may be clearly understood by a person skilled in the art that, for convenience and brevity of description, for a specific working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into units is merely logical function division and may be other division in actual implementation. For example, a plurality of units or components may be combined or integrated into another system, or some features may be ignored or not performed. In addition, the displayed or discussed mutual couplings, the direct couplings, or the communication connections may be implemented through some interfaces, and indirect couplings or communication connections between the apparatuses or the units may be connections in an electrical form, a mechanical form, or another form.

The units described as separate parts may or may not be physically separate, and parts displayed as units may or may not be physical units, to be specific, may be located in one position, or may be distributed on a plurality of network units. Some or all of the units may be selected based on actual requirements to achieve the objectives of the solutions of the embodiments in this application.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

With descriptions of the foregoing implementations, a person skilled in the art may clearly understand that this application may be implemented by hardware, firmware, or a combination thereof. When the embodiments of this application are implemented by software, the foregoing functions may be stored in a computer-readable medium or transmitted as one or more instructions or code in the computer-readable medium. The computer-readable medium includes a computer storage medium and a communications medium, and the communications medium includes any medium that enables a computer program to be transmitted from one place to another. The storage medium may be any available medium accessible to a computer. The following provides an example but does not impose a limitation. The computer-readable medium may include a RAM, a ROM, an electrically erasable programmable ROM (EEPROM), a compact disc ROM (CD-ROM), another compact disc storage or magnetic disk storage medium or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server, or another remote source through a coaxial cable, an optical fiber/cable, a twisted pair, a digital subscriber line (DSL) or wireless technologies such as infrared ray, radio, and microwave, the coaxial cable, optical fiber/cable, twisted pair, DSL, or the wireless technologies such as infrared ray, radio, and microwave are included in fixation of a medium to which they belong. A disk and a disc used in this application include a compact disc (CD), a laser disc, an optical disc, a digital versatile disc (DVD), a floppy disk, and a BLU-RAY DISC. The disk usually copies data in a magnetic manner, but the disc copies data optically through a laser. The foregoing combination should also be included in the protection scope of the computer-readable medium.

The foregoing descriptions are merely specific implementations of the embodiments of this application, but are not intended to limit the protection scope of the embodiments of this application. Any variation or replacement readily figured out by a person skilled in the art within the technical scope disclosed in the present disclosure shall fall within the protection scope of the embodiments of this application. Therefore, the protection scope of the embodiments of this application shall be subject to the protection scope of the claims.

What is claimed is:

1. An information processing method implemented by a first terminal device and comprising:
encrypting an authorization key of a current version based on a public key of a second terminal device to obtain a first authorization key ciphertext corresponding to the second terminal device; and
sending, to the second terminal device through a server, the first authorization key ciphertext, wherein the first authorization key ciphertext is configured to enable the second terminal device to decrypt, based on a private key of the second terminal device, the first authorization key ciphertext to obtain the authorization key of the current version, obtain a file key from a server based on the authorization key of the current version, and perform file decryption based on the file key.

2. The information processing method of claim 1, further comprising:
encrypting a key of an encrypted file based on the authorization key of the current version to obtain a key ciphertext of the encrypted file; and
sending the key ciphertext to the server, wherein the key ciphertext of the encrypted file enables the second terminal device to obtain the key ciphertext from the server, decrypt the key ciphertext based on the authorization key of the current version to obtain the key of the encrypted file, and decrypt, based on the key of the encrypted file, the encrypted file stored on the server.

3. The information processing method of claim 1, further comprising:
determining a random number of a preset quantity of bits; and
sending the random number to the second terminal device through the server to enable the second terminal device to determine the public key and the private key of the second terminal device.

4. The information processing method of claim 1, further comprising:
encrypting the authorization key of the current version based on a private key or a secret trapdoor parameter of the first terminal device to obtain an authorization key of a next version;
encrypting the authorization key of the next version based on a public key of a third terminal device to obtain a second authorization key ciphertext corresponding to the third terminal device; and
sending, to the third terminal device through the server, the second authorization key ciphertext to enable the third terminal device to decrypt, based on a private key of the third terminal device, the second authorization key ciphertext to obtain the authorization key of the next version, obtain the file key from the server based on the authorization key of the next version, and perform the file decryption based on the file key.

5. The information processing method of claim 4, wherein the third terminal device is a destination terminal device for file sharing after the first terminal device revokes a terminal device.

6. The information processing method of claim 4, wherein the authorization key of the next version is configured to enable each the third terminal device to decrypt the authorization key of the next version based on a public key or a public trapdoor parameter of the first terminal device to obtain the authorization key of the current version, obtain the file key from the server based on the authorization key of the current version, and perform the file decryption based on the file key.

7. The information processing method of claim 6, further comprising sending group owner change information to a target terminal device through the server, wherein the group owner change information is configured to enable the target terminal device to encrypt the authorization key of the current version based on a private key or a secret trapdoor parameter of the target terminal device to obtain the authorization key of the next version.

8. The information processing method of claim 1, further comprising:
determining, from a preset first database, an authorization key of a next version of the authorization key of the current version, wherein the preset first database comprises authorization keys of a plurality of versions of the first terminal device;
encrypting the authorization key of the next version based on a public key of a fourth terminal device to obtain a third authorization key ciphertext corresponding to the fourth terminal device; and
sending, to the fourth terminal device through the server, the third authorization key ciphertext is configured to enable the fourth terminal device to decrypt, based on a private key of the fourth terminal device, the third authorization key ciphertext to obtain the authorization key of the next version, obtain the file key from the server based on the authorization key of the next version, and perform the file decryption based on the file key.

9. An information processing method implemented by a second terminal device and comprising:
receiving a first authorization key ciphertext corresponding to the second terminal device from a first terminal device through a server, wherein the first authorization key ciphertext is based on an encryption of an authorization key of a current version based on a public key of the second terminal device;
decrypting, based on a private key of the second terminal device, the first authorization key ciphertext to obtain the authorization key of the current version;
obtaining a file key from the server based on the authorization key of the current version; and
performing a file decryption based on the file key.

10. The information processing method of claim 9, further comprising:
obtaining a key ciphertext of an encrypted file from the server, wherein the key ciphertext is based on an encryption of a key of the encrypted file based on the authorization key of the current version;
decrypting the key ciphertext based on the authorization key of the current version to obtain the key of the encrypted file; and
decrypting, based on the key of the encrypted file, the encrypted file stored on the server.

11. The information processing method of claim 9, further comprising:
receiving a random number of a preset quantity of bits from the first terminal device through the server; and
determining the public key and the private key of the second terminal device based on the random number.

12. A first terminal device comprising:
a processor configured to encrypt an authorization key of a current version based on a public key of a second terminal device to obtain a first authorization key ciphertext corresponding to the second terminal device; and
a transmitter coupled to the processor and configured to send, to the second terminal device through a server, the first authorization key ciphertext, wherein the first authorization key ciphertext is configured to enable the second terminal device to decrypt, based on a private key of the second terminal device, the first authorization key ciphertext to obtain the authorization key of the current version, obtain a file key from a server based on the authorization key of the current version, and perform a file decryption based on the file key.

13. The first terminal device of claim 12, wherein the processor is further configured to encrypt a key of an encrypted file based on the authorization key of the current version to obtain a key ciphertext of the encrypted file; and the transmitter is further configured to send the key ciphertext to the server, wherein the key ciphertext is configured to enable each the second terminal device to obtain the key ciphertext from the server, decrypt the key ciphertext based on the authorization key of the current version to obtain the key of the encrypted file, and decrypt, based on the key of the encrypted file, the encrypted file stored on the server, and wherein the transmitter is further configured to send the key ciphertext to the server.

14. The first terminal device of claim 12, wherein the processor is further configured to:
encrypt the authorization key of the current version based on a private key or a secret trapdoor parameter of the first terminal device to obtain an authorization key of a next version; and
encrypt the authorization key of the next version based on a public key of a third terminal device to obtain a second authorization key ciphertext corresponding to the third terminal device; and the transmitter is further configured to send to the third terminal device through the server, the second authorization key ciphertext, wherein the second authorization key ciphertext is configured to enable the third terminal device to decrypt, based on a private key of the third terminal device, the second authorization key ciphertext to obtain the authorization key of the next version, obtain the file key from the server based on the authorization key of the next version, and perform the file decryption based on the file key.

15. The first terminal device of claim 14, wherein the transmitter is further configured to send group owner change information to a target terminal device through the server, and wherein the group owner change information is configured to enable the target terminal device to encrypt the authorization key of the current version based on a private key or a secret trapdoor parameter of the target terminal device to obtain the authorization key of the next version.

16. The first terminal device of claim 12, wherein the processor is further configured to:
determine, from a preset first database, an authorization key of a next version of the authorization key of the current version, wherein the preset first database comprises authorization keys of a plurality of versions of the first terminal device; and
encrypt the authorization key of the next version based on a public key of a fourth terminal device to obtain a third authorization key ciphertext corresponding to the fourth terminal device; and wherein the transmitter is further configured to send, to the fourth terminal device through the server, the third authorization key ciphertext, wherein the third authorization key ciphertext is configured to enable the fourth terminal device to decrypt, based on a private key of the fourth terminal device, the third authorization key ciphertext to obtain the authorization key of the next version, obtain the file key from the server based on the authorization key of the next version, and perform the file decryption based on the file key.

17. The first terminal device of claim 16, wherein the processor is further configured to obtain the authorization keys based on a preset first random number using a preset first one-way trapdoor function.

18. The first terminal device of claim 17, wherein the processor is further configured to:
set the preset first random number as an authorization key of an n^{th} version, wherein n is an integer greater than or equal to 2;
obtain an authorization key of an (n−1)^{th} version based on the authorization key of the n^{th} version using the preset first one-way trapdoor function; and
perform the obtaining step until an authorization key of a first version is obtained.

19. The first terminal device of claim 18, wherein the transmitter is further configured to send group owner change information to a target terminal device through the server, wherein the group owner change information enables the target terminal device to obtain a second database based on a preset second random number using a preset second one-way trapdoor function, and wherein the second database comprises authorization keys of a plurality of versions of the second terminal device.
